(19) United States
(12) Patent Application Publication
(10) Pub. No.: US 2026/0284577 A1
(43) Pub. Date: Sep. 24, 2026

(54) A METHOD AND SYSTEM FOR THE REMOVAL OF CARBON DIOXIDE FROM CARBON CAPTURE SOLVENTS USING HEAT FROM A GAS

(71) Applicant: CARBON CLEAN SOLUTIONS LIMITED, London (GB)

(72) Inventors: Ausula RAMESH-KUMAR, Mumbai (IN); Prateek BUMB, London (GB); Gopinath KARUPPASAMY, Tamil Nadu (IN)

(21) Appl. No.: 18/998,055

(22) PCT Filed: Jul. 26, 2023
(86) PCT No.: PCT/GB2023/051973

§ 371 Date: Jan. 23, 2025

(30) Foreign Application Priority Data
Jul. 29, 2022 (IN) 202211043602

(51) Int. Cl. B01D 53/14; B01D 19/00

(52) U.S. Cl. CPC B01D 53/1425; B01D 19/0068; B01D 19/0073; B01D 53/1475; B01D 2252/20447; B01D 2252/20484; B01D 2257/504; B01D 2258/0283

(57) ABSTRACT

The present invention relates to a method and system for the removal of carbon dioxide (CO₂) from an upstream gas with a solvent-based system. In particular, the present invention relates to a method and a system for the regeneration of solvents and removal of CO₂ from CO₂ rich solvent streams wherein the method and system use heat from an upstream gas for the regeneration.

### FIELD OF THE INVENTION

The present invention relates to a method and system for the removal of carbon dioxide (CO₂) from an upstream gas with a solvent-based system. Typically, the upstream gas is a flue gas. However, the gas can also be cement kiln gas, blast furnace gas, syngas, biogas or other gases which require the removal of CO₂. In particular, the present invention relates to a method and a system for the regeneration of solvents and removal of CO₂ from CO₂ rich solvent streams wherein the method and system use heat from an upstream gas for the regeneration.

### BACKGROUND OF THE INVENTION

Flue gases from power plants and other industrial activities include pollutants, for example greenhouse gases. One such greenhouse gas is CO₂. Emissions of CO₂ to the atmosphere from industrial activities are of increasing concern to society and are therefore becoming increasingly regulated. To reduce the amount of CO₂ released into the atmosphere, CO₂ capture technology can be applied. The selective capture of CO₂ not only minimizes the amount of CO₂ released into the atmosphere, but also allows CO₂ to be re-used or geographically sequestered. CO₂ capture methods can be applied to CO₂ capture from flue gases and industrial gases, e.g., emissions from plants that burn hydrocarbon fuel. CO₂ capture methods are also applicable to CO₂ capture from coal, gas and oil-fired boilers, combined cycle power plants, coal gasification, hydrogen plants, biogas plants, waste to energy plants, steel plants, refineries, cement kilns, blast furnaces, or any other plant which produces a flue gas.

CO₂ capture methods can be divided into physical adsorbents and chemical absorbents (commonly referred to as carbon capture solvents). For CO₂ capture methods, the carbon capture solvent removes CO₂ from one or more gas streams. The CO₂ in the gas streams selectively reacts with components in the solvent, resulting in CO₂ being removed from the gas phase and absorbed by the solvent to form a CO₂ rich solvent. The CO₂ rich solvent is then heated resulting in CO₂ being released back into the gas phase and the CO₂ rich solvent being depleted of its CO₂ content resulting in the formation of a CO₂ lean solvent. The CO₂ lean solvent is recycled within the system to capture additional CO₂. Examples of known methods using a carbon capture solvent to remove CO₂ from a flue gas include the methods described in CN107970743, US2016/0166976, US2011/0113965 and US20160166976A (all incorporated by reference in their entirety).

Conventional Method and System for Capturing CO₂ from Flue Gases

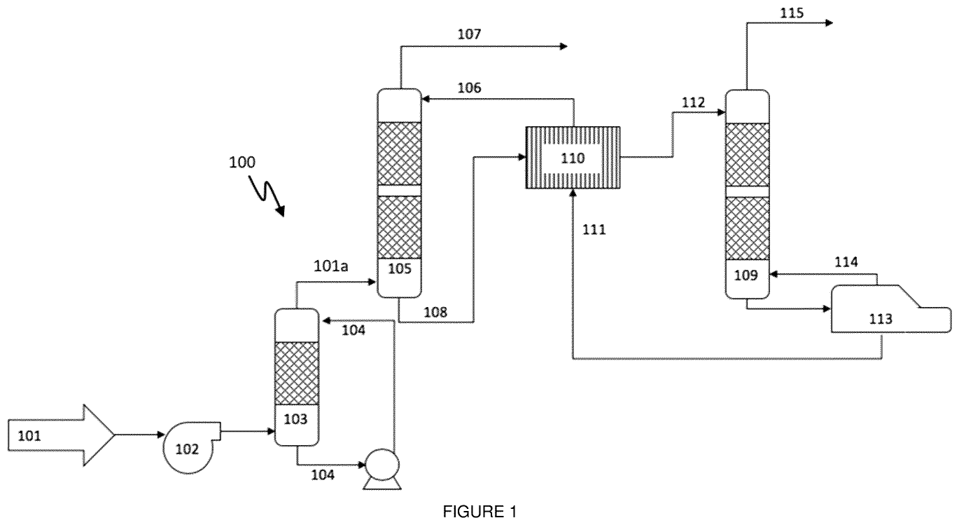

FIG. 1 illustrates a schematic diagram 100 of a conventional system 100 for capturing CO₂ from flue gases. In the conventional system 100 for capturing CO₂ from flue gases shown in FIG. 1, CO₂ is separated from a mixture of gases using a solvent (initially a CO₂ lean solvent), which selectively reacts with the CO₂ (to form a CO₂ rich solvent). After the CO₂ has reacted with the solvent (CO₂ lean solvent), the solvent (CO₂ rich solvent) can be regenerated (to CO₂ lean solvent) using heat to release the CO₂ and regenerate the solvent for further CO₂ processing.

As shown in FIG. 1, a flue gas 101 containing CO₂ enters the system 100. The temperature of the flue gas 101 when entering the system 100 is typically greater than 100° C., typically from 120 to 200° C. The flue gas 101 optionally passes through a booster fan 102. The booster fan 102 increases the pressure of flue gas 101 to compensate for the pressure drop through the system, thereby ensuring that the pressure of the resultant CO₂ lean flue gas (flue gas 107) is at the same pressure as flue gas 101. The flue gas 101 then passes through flue gas pre-treatment section. In the flue gas pre-treatment section, the flue gas 101 passes through a direct contact cooler 103. In the direct contact cooler 103, the flue gas 101 is contacted with a recirculating loop of cool water 104 in a counter-current configuration. Through this contact, the flue gas 101 is cooled to a temperature of typically 40° C., forming flue gas 101a. The cooled flue gas is typically cooled to a temperature of 40° C. Through contact with the cool water dust particles if any are removed from the flue gas.

Prior to passing to an absorber 105, the flue gas 101a is optionally pre-treated to remove SO₂, NOₓ and dust through contact of the flue gas with an alkali solution.

The flue gas 101a enters the absorber 105, where the flue gas 101a is contacted with a cool, CO₂ lean solvent 106 in a counter-current configuration. The cool, CO₂ lean solvent 106 is typically at a temperature of 40° C. The flue gas 101a rises through the absorber 105. The cool, CO₂ lean solvent 106 enters the absorber 105 via a liquid distributor (not shown in FIG. 1) positioned at the top of the absorber 105, and cascades down through the absorber column 105. The absorber 105 contains packing to maximise the surface area to volume ratio. The active components in the cool, CO₂ lean solvent 106 react with the CO₂ in the flue gas 101a. When the cool, CO₂ lean solvent 106 reaches the bottom of the absorber 105, it is rich in CO₂ and forms cool, CO₂ rich solvent 108. When the flue gas 101a reaches the top of absorber 105, it is depleted of CO₂ and forms CO₂ lean flue gas 107. The CO₂ lean flue gas 107 is released from the top of the absorber 105.

The cool, CO₂ rich solvent 108 is regenerated in regenerator 109, to reform cool, CO₂ lean solvent 106. The cool, CO₂ rich solvent 108 enters the regenerator 109 via a cross-over heat exchanger 110. In the cross-over heat exchanger 110, the cool, CO₂ rich solvent 108 is heated by a high-heat, CO₂ lean solvent 111 to form high-heat, CO₂ rich solvent 112. The high-heat, CO₂ rich solvent 112 is typically at a temperature of from 100 to 120° C., preferably at a temperature of 110° C. The high-heat, CO₂ rich solvent 112 enters the top of the regenerator 109 and cascades down the regenerator 109. Inside the regenerator, the high-heat, CO₂ rich solvent 112 is heated further through contact with a hot vapour 114. Typically, the hot vapour 114 flows upwards through the regenerator 109, counter-current to the high-heat, CO₂ rich solvent 112. Typically, the hot vapour 114 is at a temperature of 120° C. or greater, preferably at a temperature of 120° C. Upon heating, the reaction between the active components of the solvent and CO₂ reverses, releasing CO₂ gas 115 and forming a high-heat, CO₂ lean solvent 111. Typically, the high-heat, CO₂ lean solvent 111 is at a temperature of from 100 to 120° C., preferably at a temperature of 120° C. Gaseous CO₂ 115 leaves the top of the regenerator 109. Gaseous CO₂ 115 can be used in downstream processes.

The hot, CO₂ lean solvent 111 is fed into a reboiler 113. Typically, the reboiler 113 is operating at a temperature of 120° C. or greater, preferably at a temperature of 120° C. Within the reboiler 113, the high-heat, CO₂ lean solvent 111 is boiled resulting in formation of a hot vapour 114. Typically, the hot vapour is at a temperature of from 120° C. or greater, preferably at a temperature of 120° C. Typically, the hot vapour comprises CO₂ and water vapour. The hot vapour 114 is used in the regenerator 109.

The high-heat, CO₂ lean solvent 111 passes into the cross-over heat exchanger 110 and is cooled though contact with the cool, CO₂ rich solvent 108 to form cool, CO₂ lean solvent 106. Typically, the cool, CO₂ lean solvent 106 is at a temperature of from 40 to 60° C., preferably at a temperature of 55° C. The cool, CO₂ lean solvent 106 then passes through an additional cooler (not shown) before entering the absorber column 105. In the additional cooler, the cool, CO₂ lean solvent 106 is cooled to a temperature of 40° C. The freshly formed cool, CO₂ lean solvent 106 is now ready to repeat the absorption process again.

In typical CO₂ capture methods that use carbon capture solvents, regeneration of the carbon capture solvents requires a high amount of energy. The energy required can be split into three factors: (1) heat of absorption, (2) solvent sensible heat, and, (c) latent heat of vapourisation of water. The heat of absorption is limited by solvent chemistry, the solvent sensible heat is limited by the exchange of heat between carbon dioxide rich and lean solvents and the latent heat of vapourisation is dependent on the pressure and temperature of the regenerator as well as the water content of the solvent. Regeneration of the carbon capture solvent uses about 60 to 70% of the total cost of the carbon capture plant, and thus regeneration of the carbon capture solvents is one of the largest operating costs for capturing CO₂. To address this need, the conventional method and system for capturing CO₂ from flue gases has been adapted to reduce the energy used in the regeneration.

Adapted Conventional Method and System for Capturing CO₂ from Flue Gases

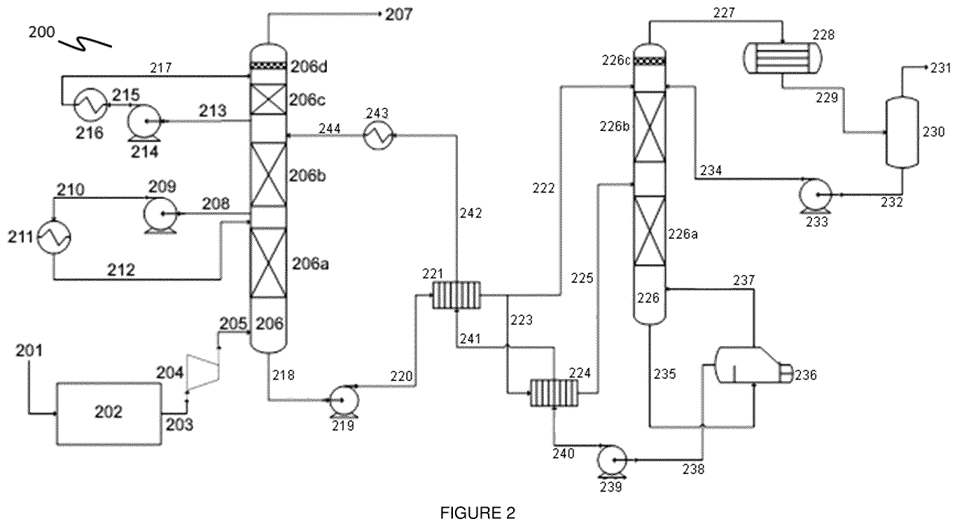

FIG. 2 illustrates a schematic diagram of an adapted conventional system 200 for capturing CO₂ from flue gases. In the adapted convention system 200 for capturing CO₂ from flue gases shown in FIG. 2, CO₂ is separated from a mixture of gases using a solvent (initially a CO₂ lean solvent), which selectively reacts with the CO₂ (to form a CO₂ rich solvent). After the CO₂ has reacted with the solvent (CO₂ lean solvent), the solvent (CO₂ rich solvent) can be regenerated (to CO₂ lean solvent) using heat to release the CO₂ and regenerate the solvent for further CO₂ processing.

As shown in FIG. 2, a flue gas 201 containing CO₂ enters the system 200. The temperature of the flue gas 201 when entering the system 200 is typically greater than 100° C., typically from 120 to 200° C. The flue gas 201 optionally passes through a flue gas pre-treatment section 202. In the flue gas pre-treatment section 202, the flue gas 201 passes through a direct contact cooler. In the direct contact cooler, the flue gas 201 is contacted with a recirculating loop of cool water in a counter-current configuration. Through this contact, the flue gas 201 is cooled. The cooled flue gas forms flue gas 203, which is cooled to a temperature of typically 40° C. Through contact with an alkali solution, SO₂, NO₂ if any present in the flue gas are removed from the flue gas 201. The flue gas 203 then passes through a booster fan 204. The booster fan 204 increases the pressure of the flue gas 203 to compensate for the pressure drop through the system 200, thereby ensuring that the pressure of the resultant CO₂ lean flue gas (flue gas 207) is at the same pressure as flue gas 201, or just above at a pressure of 5 mbarg.

The flue gas 205 enters the absorber 206 below packing 206a, where the flue gas 205 is contacted with a cool, CO₂ lean solvent 244 in a counter-current configuration. The cool, CO₂ lean solvent 244 is typically at a temperature of 40° C. The flue gas 205 rises through the absorber 206. The cool, CO₂ lean solvent 244 enters the absorber 206 via a liquid distributor (not shown in FIG. 2) between packing 206b and 206c, and cascades down through the absorber 206. The absorber 206 contains packing to maximise the surface area to volume ratio: the packing is shown by references 206a, 206b and 206c in FIG. 2. To maintain the temperature of the absorber 206, the location of the packing (the intercooling sections) and the height of each packing will be optimised on a case-to-case basis. Once the cool, CO₂ lean solvent 244 has passed through packing 206b, a cool, CO₂ lean solvent 208 is formed and the cool, CO₂ lean solvent 208 passes to an absorber interstage pump 209 forming cool, CO₂ lean solvent 210. Approximately, 90 to 100 wt. % of the cool, CO₂ lean solvent 244 passes through the interstage pump 209, instead of passing directly down through the absorber 206. The cool, CO₂ lean solvent 244 that passes through the interstage pump 209 is labelled 208 in FIG. 2. The absorber interstage pump 209 is used to feed the cool, CO₂ lean solvent 210 back into the absorber 206. The cool, CO₂ lean solvent 210 then passes to an absorber interstage cooler 211 forming cool, CO₂ lean solvent 212. The absorber interstage cooler 211 removes any excess heat from the solvent during the exothermic CO₂ absorption reaction. The cool, CO₂ lean solvent 212 then continues to cascade through absorber 206. The active components in the cool, CO₂ lean solvent 212 react with the CO₂ in the flue gas 205. Advantageously, by cooling part of the cool, CO₂ lean solvent the temperature of the cool, CO₂ lean solvent is reduced in the bottom section of the absorber 206 (i.e., in the section below packing 206b. A cool, CO₂ lean solvent with a reduced temperature will have an increased loading of CO₂, which in turn reduces the heat of absorption energy required by the absorber 206.

When the cool, CO₂ lean solvent 212 reaches the bottom of the absorber 206, it is rich in CO₂ and forms cool, CO₂ rich solvent 218.

As the flue gas 205 passes up through the absorber 206, it is depleted of CO₂ and eventually forms CO₂ lean flue gas 207. When the flue gas 205 has passed through packing 206b, a CO₂ lean flue gas is formed. The CO₂ lean flue gas passes through a water wash section with packing 206c to recover any solvent present in the flue gas 205. The wash water 213 passes through a water wash pump 214, which provides sufficient pressure to feed the wash water back into the absorber 206. Once the wash water 213 has passed through the wash water pump 214, wash water 215 is formed. Wash water 215 passes through a water wash cooler 216 to form wash water 217. The water wash cooler is required to cool the flue gas 205 to recover water and any solvent present. The wash water 217 then enters the absorber 206. Once the flue gas has been washed, the flue gas continues to pass up through the absorber 206 to be released from the top of the absorber 206 as CO₂ lean flue gas 207. The absorber 206 further includes a demister 206d, through which the CO₂ lean flue gas 207 passes through before leaving the absorber 206. The demister is used to enhance the removal of liquid droplets from the flue gas 207.

The cool, CO₂ rich solvent 218 is regenerated in regenerator 226 to form cool, CO₂ lean solvent 244. The regenerator 226 contains packing to maximise the surface area to volume ratio: the packing is shown by references 226a and 226b, and a demister is shown by reference 226c in FIG. 2. The packing 226a is present in the half of the regenerator 226 connected to a reboiler 236, this part is the top of the regenerator 226. The packing 226b is present in the half of the regenerator 226 connected to a condenser 228, this part of the regenerator is the top of the regenerator 226. The packing is placed in the specific locations in the regenerator 226 to maintain the required temperature profile in the regenerator 226.

The cool, CO₂ rich solvent 218 enters the regenerator 226 via one of two pathways.

For both pathways, the cool, CO₂ rich solvent 218 passes through a solvent pump 219 to form cool, CO₂ rich solvent 220. The solvent pump 219 is used to overcome the pressure loss of the cool, CO₂ rich solvent 218 on the path to the regenerator 226. The cool, CO₂ rich solvent 220 then passes through a cross-over heat exchanger 221. In the cross-over heat exchanger 221, the cool, CO₂ rich solvent 220 is heated by a low-heat, CO₂ lean solvent 241 to form a low-heat, CO₂ rich solvent. Typically, the low-heat, CO₂ lean solvent 241 is at a temperature of from 60 to 80° C., preferably at a temperature of from 70 to 80° C., preferably at a temperature of 70° C. The low-heat, CO₂ rich solvent is at a temperature of from 60 to 80° C., preferably at a temperature of from 60 to 70° C., preferably at a temperature of 60° C. The cross-over heat exchanger 221 helps to reduce the heat lost from the CO₂ lean solvent in a cooler 243 further downstream: by minimising the heat lost at this stage, the amount of sensible heat required to regenerate the carbon capture solvent is reduced.

The low-heat CO₂ rich solvent is split into two streams: low heat, CO₂ rich solvent 222 and low-heat, CO₂ rich solvent 223. Typically, the split is 10-40 weight % to low-heat, CO₂ rich solvent 222 and 60 to 90 weight % to low-heat, CO₂ rich solvent 223.

The low-heat, CO₂ rich solvent 222 enters the regenerator 226 between packing 226b and 226c and cascades down the regenerator 226.

The low-heat, CO₂ rich solvent 223 passes to a cross-over heat exchanger 224. In the cross-over heat exchanger 224, the low-heat, CO₂ rich solvent 223 is heated by a high-heat, CO₂ lean solvent 240 to form a high-heat, CO₂ rich solvent 225. Typically, the high-heat, CO₂ lean solvent 240 is at a temperature of from 100 to 120° C., preferably at a temperature of 120° C. Typically, the high-heat CO₂ rich solvent 225 is at a temperature of from 100 to 120° C., preferably at a temperature of 110° C. The high-heat, CO₂ rich solvent 225 enters the regenerator 226 between packing 226a and 226b and cascades down the regenerator 226.

Inside the regenerator 226, water vapourisation and CO₂ stripping from the CO₂ rich solvent occurs. Advantageously, by providing a low-heat, CO₂ rich solvent 222 and a high-heat, CO₂ rich solvent 225, a high temperature at the bottom of the regenerator 226 (i.e., below packing 226a) can be achieved, and a low temperature at the top of the regenerator 226 (i.e., above packing 226b) can be achieved. By maintaining a high temperature at the bottom of the regenerator 226, the reaction between the active components in the carbon capture solvent and CO₂ can be reversed. By maintaining a low temperature at the top of the regenerator 226, the heat of water vapourisation can be recovered by any water vapour present at the top of the regenerator 226 passing heat to the low-heat CO₂ rich solvent 222.

Inside the regenerator 226, the low-heat, CO₂ rich solvent 222 and high-heat, CO₂ rich solvent 225 are heated through contact with hot vapour 237. Typically, the hot vapour 237 flows upwards through the regenerator 226, in a counter-current configuration to the low heat, CO₂ rich solvent 222 and high-heat, CO₂ rich solvent 225. Upon heating, the reaction between the active components of the solvents and CO₂ reverses, releasing CO₂ and water vapour 227 and forming a high-heat, CO₂ lean solvent 235.

The CO₂ and water vapour 227 pass to a stripper condenser 228 operating at a temperature of from 35 to 40° C. The stripper condenser 228 forms a condensate 229 from the water vapour, which passes to a reflux drum 230 to form reflux condensate 232. The reflux drum separates CO₂ vapour 231 and the reflux condensate 232. The reflux condensate 232 then passes to a reflux pump 233 to form reflux condensate 234. The reflux pump 233 is used to move the reflux condensate 234 back into the regenerator 226. The reflux condensate 234 then passes back into the regenerator 226 between packing 226b and demister 226c. Having passed through the stripper condenser 228, the condensate 229 and the subsequently formed reflux condensate 232 and reflux condensate 234 are at a temperature of from 35 to 40° C.

A gaseous CO₂ 231 is formed in the reflux drum 230. The gaseous CO₂ 231 is the CO₂ product stream and can be used in downstream processes.

The high-heat, CO₂ lean solvent 235 is fed into a reboiler 236. Typically, the reboiler 236 is operating at a temperature of 120° C. or greater, preferably at a temperature of 120° C. Within the reboiler 236, the high-heat, CO₂ lean solvent 235 is boiled resulting in the formation of hot vapour 237 and high-heat, CO₂ lean solvent 238. Typically, the hot vapour 237 is at a temperature of from 120° C. or greater, preferably at a temperature of 120° C. Typically, the hot vapour 237 comprises CO₂ and water vapour. The hot vapour 237 is used in the regenerator 226, and the hot vapour 237 enters the regenerator below packing 226a. Typically, the high-heat, CO₂ lean solvent 238 is at a temperature of 120° C.

The high-heat, CO₂ lean solvent 238 passes to a solvent pump 239 to form high-heat, CO₂ lean solvent 240. The solvent pump 239 is used to move the high-heat, CO₂ lean solvent 238 to the cross-over heat exchanger 224. The high-heat, CO₂ lean solvent 240 then passes to the cross-over heat exchanger 224. In the cross-over heat-exchanger 224, the high-heat, CO₂ lean solvent 240 is cooled to form low-heat, CO₂ lean solvent 241. Typically, the low-heat, CO₂ lean solvent 241 is at a temperature of from 60 to 80° C., preferably at a temperature of from 70 to 80° C., preferably at a temperature of 70° C. The low-heat, CO₂ lean solvent 241 then passes to the cross-over heat exchanger 221. In the cross-over heat-exchanger 221, the low-heat, CO₂ lean solvent 241 is cooled by exchanging heat with cool, CO₂ rich solvent 220 to form cool, CO₂ lean solvent 242. Typically, the cool, CO₂ lean solvent 242 is at a temperature of from 40 to 60° C., preferably at a temperature of 55° C. The cool, CO₂ lean solvent 242 passes to a cooler 243 to form cool, CO₂ lean solvent 244. In the cooler 243, the cool, CO₂ lean solvent 242 is cooled to 40° C. to form cool, CO₂ lean solvent 244. Cool, CO₂ lean solvent 244 is ready to enter absorber column 206.

By using cross-over heat exchangers 221 and 224, the sensible heat from high-heat, CO₂ lean solvent 240 and low-heat, CO₂ lean solvent 241 can be recovered, which helps in maintaining a high temperature at the bottom of regenerator 226 (by forming high-heat, CO₂ rich solvent 225) and a low temperature at the top of the regenerator 226 (by forming low-heat, CO₂ rich solvent 222). By maintaining the high and low temperatures, the heat generated in the reboiler 236 is used effectively (and not just lost), thereby reducing the amount of energy required in the regeneration of the cool, CO₂ lean solvent 244, and thus also reducing the cost of the regeneration.

However, there is still a need for improved methods of reducing the energy, and thus the cost, required to capture CO₂. In particular, there is a need to reduce the energy required, and thus the cost, of regenerating the carbon capture solvent. The present invention addresses this need.

### SUMMARY OF THE INVENTION

The present invention relates to a method and system for the removal of carbon dioxide (CO₂) from an upstream gas with a solvent-based system. Typically, the upstream gas is a flue gas. However, the gas can also be cement kiln gas, blast furnace gas, syngas, biogas or other gases which require the removal of CO₂. In particular, the present invention relates to a method and a system for the regeneration of solvents and removal of CO₂ from CO₂ rich solvent streams wherein the method and system use heat from an upstream gas for the regeneration.

Representative features of the present invention are set out in the following clauses, which stand alone or may be combined, in any combination, with one or more features disclosed in the text and/or figures of the specification.

The present invention is as set out in the following clauses:
1. A method for regenerating a solvent comprising carbon dioxide (CO₂), the method comprising:
   providing a flue gas comprising carbon dioxide (CO₂);
   passing the flue gas comprising carbon dioxide (CO₂) through a first heat exchanger, wherein heat from the flue gas is exchanged with a fluid to form a heated fluid and a cooled flue gas;
   passing the heated fluid through a regenerator;
   providing a solvent comprising carbon dioxide (CO₂);
   passing the solvent comprising carbon dioxide (CO₂) through the regenerator, wherein heat from the heated fluid heats the solvent comprising carbon dioxide (CO₂) to form a solvent comprising a reduced amount of carbon dioxide (CO₂).
2. The method of clause 1, wherein the fluid is:
   a CO₂ rich solvent; or,
   a reflux condensate; or,
   a pre-heated reflux condensate.
3. The method of clause 1 or clause 2, wherein the fluid is a reflux condensate and the method comprises the further step of:
   passing the cooled flue gas comprising carbon dioxide (CO₂) through a second heat exchanger wherein heat from the cooled flue gas is exchanged with a CO₂ rich solvent.
4. The method of clause 1 or clause 2, wherein the fluid is a pre-heated reflux condensate and the method comprises the further step of:
   passing the cooled flue gas comprising carbon dioxide (CO₂) through a second heat exchanger wherein heat from the cooled flue gas is exchanged with a CO₂ rich solvent.
5. The method of any one of clauses 1 to 4, wherein the first heat exchanger decreases the temperature of the flue gas to from 40 to 90° C., or, from 50 to 85° C., or, from 55 to 80° C., or, 70° C.
6. The method of any one of clauses 1 to 4, wherein the first heat exchanger decreases the temperature of the flue gas to from 60 to 130° C., or, from 70 to 120° C., or, from 80 to 110° C., or, 90° C.
7. The method of any one of clauses 1 to 6, wherein the first heat exchanger increases the temperature of the fluid to from 45 to 95° C., or, from 50 to 90° C., or, from 55 to 85° C., or, from 60 to 80° C.
8. The method of any one of clauses 1 to 6, wherein the first heat exchanger increases the temperature of the fluid to from 90 to 140° C., or, from 100 to 135° C., or, from 110 to 130° C., or, 120° C.
9. The method of any one of clauses 1 to 6, wherein the fluid is a CO₂ rich solvent and the first heat exchanger increases the temperature of the CO₂ rich solvent to from 45 to 95° C., or, from 50 to 90° C., or, from 55 to 85° C., or, from 60 to 80° C.
10. The method of any one of clauses 1 to 6, wherein the fluid is a reflux condensate, and the first heat exchanger increases the temperature of the reflux condensate to from 90 to 140° C., or, from 100 to 135° C., or, from 110 to 130° C., or, 120° C.
11. The method of any one of clauses 1 to 6, wherein the fluid is a pre-heated reflux condensate, and the first heat exchanger increases the temperature of the pre-heated reflux condensate to from 90 to 140° C., or, from 100 to 135° C., or, from 110 to 130° C., or, 120° C.
12. The method of clause 10, wherein the second heat exchanger increases the temperature of the CO₂ rich solvent to from 45 to 95° C., or, from 50 to 90° C., or, from 55 to 85° C., or, from 60 to 80° C., or, from 70 to 80° C., or, to 75° C.
13. The method of clause 11, wherein the second heat exchanger increases the temperature of the CO₂ rich solvent to from 45 to 95° C., or, from 50 to 90° C., or, from 55 to 85° C., or, from 60 to 80° C., or, from 70 to 80° C., or, to 75° C.
14. The method of any one of clauses 1 to 13, further comprising the step of passing the cooled flue gas through the first heat exchanger, or, the second heat exchanger, or, the first heat exchanger and the second heat exchanger, wherein the first heat exchanger, or, the second heat exchanger, or, the first heat exchanger and the second heat exchanger is (are) in fluid communication with the regenerator.
15. The method of any one of clauses 1 to 14, further comprising the step of passing the solvent comprising a reduced amount of carbon dioxide (CO₂) through a reboiler, wherein the reboiler is in fluid communication with the regenerator.
16. The method of any one of clauses 1 to 15, wherein the fluid is a CO₂ rich solvent and the CO₂ rich solvent enters the top of the regenerator, wherein the top of the regenerator is the part of the regenerator in fluid communication with the condenser.
17. The method of any one of clauses 1 to 16, wherein the fluid is a reflux condensate, wherein upon passing the reflux condensate through the first heat exchanger a hot vapour is formed and the hot vapour enters the bottom of the regenerator, wherein the bottom of the regenerator is the part of the regenerator in fluid communication with the reboiler.
18. The method of any one of clauses 1 to 17, wherein the fluid is the pre-heated reflux condensate, wherein upon passing the pre-heated reflux condensate through the first heat exchanger a hot vapour is formed and the hot vapour enters the bottom of the regenerator, wherein the bottom of the regenerator is the part of the regenerator in fluid communication with the reboiler.
19. The method of any one of clauses 1 to 18, wherein the regenerator operates at a temperature in the range of equal to or greater than 120° C., or, from 120 to 140° C., or, from 120 to 130° C.
20. The method of any one of clauses 1 to 19, wherein the CO₂ rich solvent has a concentration of carbon dioxide (CO₂) of from 2 to 3.3 mol L⁻¹.
21. The method of any one of clauses 1 to 20, wherein the CO₂ lean solvent has a concentration of carbon dioxide (CO₂) from 0.0 to 0.7 mol L⁻¹.
22. The method of any one of clauses 1 to 21, wherein the step of providing a solvent comprising carbon dioxide (CO₂) further comprises:
   contacting a flue gas with carbon dioxide (CO₂) lean solvent within one, two, three, four, five, six, seven, eight, nine or ten, or more, absorber column(s), wherein the absorber column(s) is (are) in fluid communication with the regenerator.
23. The method of clause 22, wherein the absorber column(s) is (are) in fluid communication with the regenerator through at least one cross-over heat exchanger.
24. The method of clause 22 or clause 23, wherein the absorber column comprises, or consists, of a packed column, a static column, or, a rotating packed bed.
25. The method of any one of clauses 1 to 24, wherein the solvent is an intensified solvent; optionally, an intensified solvent comprising a tertiary amine, or, a secondary amine, or, a primary amine; optionally, an intensified solvent further comprising a tertiary amine, a sterically hindered amine, a polyamine, a salt and water; optionally, wherein the solvent is CDRMax or, MEA.
26. The method of any one of clauses 1 to 25, wherein the flue gas is from a coal, gas and/or oil-fired boiler, combined cycle power plant, coal gasification plant, hydrogen plant, biogas plant, waste to energy plant, steel plants, refineries, cement kiln, blast furnace, or any other plant which produces a flue gas.
27. The method of any one of clauses 1 to 26, wherein the flue gas has an initial carbon dioxide (CO₂) concentration of from 2.5 volume % (dry) to 51 volume % (dry), or, from 3 volume % (dry) to 12 volume % (dry), or, from 15 volume % (dry) to 22 volume % (dry), or, from 30 volume % (dry) to 45 volume % (dry).
28. The method of any one of clauses 1 to 27, wherein the regenerator is either a static column or a Rotary Packed Bed (RPB).
29. A system for regenerating a solvent comprising carbon dioxide (CO₂), the system comprising:
   a first heat exchanger;
   a regenerator;
   wherein the first heat exchanger is configured to exchange heat between a flue gas comprising carbon dioxide (CO₂) and a fluid to form a heated fluid and a cooled flue gas;
   wherein the regenerator is configured to exchange heat between the heated flue gas and a solvent comprising carbon dioxide (CO₂) to provide energy for regenerating the solvent by removing carbon dioxide (CO₂).
30. The system of clause 29, wherein the fluid is:
   a CO₂ rich solvent; or,
   a reflux condensate; or,
   a pre-heated reflux condensate.
31. The system of clause 29 or clause 30, wherein the fluid is a reflux condensate and the system further comprises:
   a second heat exchanger;
   wherein the second heat exchanger is configured to exchange heat from the cooled flue gas with a CO₂ rich solvent.
32. The system of clause 29 or clause 30, wherein the fluid is a pre-heated reflux condensate and the system comprises:
   a second heat exchanger;
   wherein the second heat exchanger is configured to exchange heat from the cooled flue gas with a CO₂ rich solvent.
33. The system of any one of clauses 29 to 32, wherein the first heat exchanger decreases the temperature of the flue gas to from 40 to 90° C., or, from 50 to 85° C., or, from 55 to 80° C.
34. The system of any one of clauses 29 to 32, wherein the first heat exchanger decreases the temperature of the flue gas to from 60 to 130° C., or, from 70 to 120° C., or, from 80 to 110° C., or, 90° C.
35. The system of any one of clauses 29 to 34, wherein the first heat exchanger increases the temperature of the fluid to from 45 to 95° C., or, from 50 to 90° C., or, from 55 to 85° C., or, from 60 to 80° C., or from 70 to 80° C., or to 75° C.
36. The system of any one of clauses 29 to 34, wherein the first heat exchanger increases the temperature of the fluid to from 90 to 140° C., or, from 100 to 135° C., or, from 110 to 130° C., or, to 120° C.
37. The system of any one of clauses 29 to 34, wherein the fluid is a CO₂ rich solvent and the first heat exchanger increases the temperature of the CO₂ rich solvent to from 45 to 95° C., or, from 50 to 90° C., or, from 55 to 85° C., or, from 60 to 80° C., or, from 70 to 80° C., or, to 75° C.
38. The system of any one of clauses 29 to 34, wherein the fluid is a reflux condensate, and the first heat exchanger increases the temperature of the reflux condensate to from 90 to 140° C., or, from 100 to 135° C., or, from 110 to 130° C., or, to 120° C.
39. The system of any one of clauses 29 to 34, wherein the fluid is a pre-heated reflux condensate, and the first heat exchanger increases the temperature of the pre-heated reflux condensate to from 90 to 140° C., or, from 100 to 135° C., or, from 110 to 130° C., or, to 120° C.
40. The system of clause 38, wherein the second heat exchanger increases the temperature of the CO₂ rich solvent to from 45 to 95° C., or, from 50 to 90° C., or, from 55 to 85° C., or, from 60 to 80° C., or, from 70 to 80° C., or, to 75° C.
41. The system of clause 39, wherein the second heat exchanger increases the temperature of the CO₂ rich solvent to from 45 to 95° C., or, from 50 to 90° C., or, from 55 to 85° C., or, from 60 to 80° C., or, from 70 to 80° C., or, to 75° C.
42. The system of any one of clauses 29 to 41, further comprising the step of passing the cooled flue gas through the first heat exchanger, or, the second heat exchanger, or, the first heat exchanger and the second heat exchanger, wherein the first heat exchanger, or, the second heat exchanger, or, the first heat exchanger and the second heat exchanger is (are) in fluid communication with the regenerator.
43. The system of any one of clauses 29 to 42, further comprising the step of passing the solvent comprising a reduced amount of carbon dioxide (CO₂) through a reboiler, wherein the reboiler is in fluid communication with the regenerator.
44. The system of any one of clauses 29 to 43, wherein the fluid is a CO₂ rich solvent and the CO₂ rich solvent enters the top of the regenerator, wherein the top of the regenerator is the part of the regenerator connected to the condenser.
45. The system of any one of clauses 29 to 44, wherein the fluid is a reflux condensate, wherein upon passing the reflux condensate through the first heat exchanger a hot vapour is formed and the hot vapour enters the bottom of the regenerator, wherein the bottom of the regenerator is the part of the regenerator connected to the reboiler.
46. The system of any one of clauses 29 to 45, wherein the fluid is a pre-heated reflux condensate, wherein upon passing the pre-heated reflux condensate through the first heat exchanger a hot vapour is formed and the hot vapour enters the bottom of the regenerator, wherein the bottom of the regenerator is the part of the regenerator connected to the reboiler.
47. The system of any one of clauses 29 to 46, wherein the regenerator operates at a temperature in the range of equal to or greater than 120° C., or, from 120 to 140° C., or, from 120 to 130° C.
48. The system of any one of clauses 29 to 47, wherein the CO₂ rich solvent has a concentration of carbon dioxide (CO₂) of from 2 to 3.3 mol L⁻¹.
49. The system of any one of clauses 29 to 48, wherein the CO₂ lean solvent has a concentration of carbon dioxide (CO₂) of from 0.0 to 0.7 mol L⁻¹.
50. The system of any one of clauses 29 to 49, wherein the step of providing a solvent comprising carbon dioxide (CO₂) further comprises:
   contacting a flue gas with carbon dioxide (CO₂) lean solvent within one, two, three, four, five, six, seven, eight, nine or ten, or more, absorber columns, wherein the absorber column(s) is (are) in fluid communication with regenerator.
51. The system of clause 50, wherein the absorber column(s) is (are) in fluid communication with the regenerator through at least one cross-over heat exchanger.
52. The method of clause 50 or clause 51, wherein the absorber column comprises, or consists, of a packed column, a static column, or, a rotating packed bed.
53. The system of any one of clauses 29 to 52, wherein the solvent is an intensified solvent; optionally, an intensified solvent comprising a tertiary amine, or, a secondary amine, or, a primary amine; optionally, an intensified solvent further comprising a tertiary amine, a sterically hindered amine, a polyamine, a salt and water; optionally, wherein the solvent is CDRMax, or, MEA.
54. The system of any one of clauses 29 to 53, wherein the flue gas is from a coal, gas and/or oil-fired boiler, combined cycle power plant, coal gasification plant, hydrogen plant, biogas plant, waste to energy plant, steel plants, refineries, cement kiln, blast furnace, or any other plant which produces a flue gas.
55. The system of any one of clauses 29 to 54, wherein the flue gas has an initial carbon dioxide (CO₂) concentration of from 2.5 volume % (dry) to 51 volume % (dry), or, from 3 volume % (dry) to 12 volume % (dry), or, from 15 volume % (dry) to 22 volume % (dry), or, from 30 volume % (dry) to 45 volume % (dry).
56. The system of any one of clauses 29 to 55, wherein the regenerator is either a static column or a Rotary Packed Bed (RPB).

### DETAILED DESCRIPTION

Embodiments of the invention are described below with reference to the accompanying drawings. The accompanying drawings illustrate various embodiments of systems, methods, and embodiments of various other aspects of the disclosure. Any person with ordinary skills in the art will appreciate that the illustrated element boundaries (e.g., boxes, groups of boxes, or other shapes) in the figures represent one example of the boundaries. It may be that in some examples one element may be designed as multiple elements or that multiple elements may be designed as one element. In some examples, an element shown as an internal component of one element may be implemented as an external component in another and vice versa. Furthermore, elements may not be drawn to scale. Non-limiting and non-exhaustive descriptions are described with reference to the following drawings. The components in the figures are not necessarily to scale, emphasis instead being placed upon illustrating principles.

FIG. 1 is a schematic diagram of a conventional system 100 that is used in capturing CO₂ from flue gases.

FIG. 2 is a schematic diagram of a conventional system 200 that is used in capturing CO₂ from flue gases.

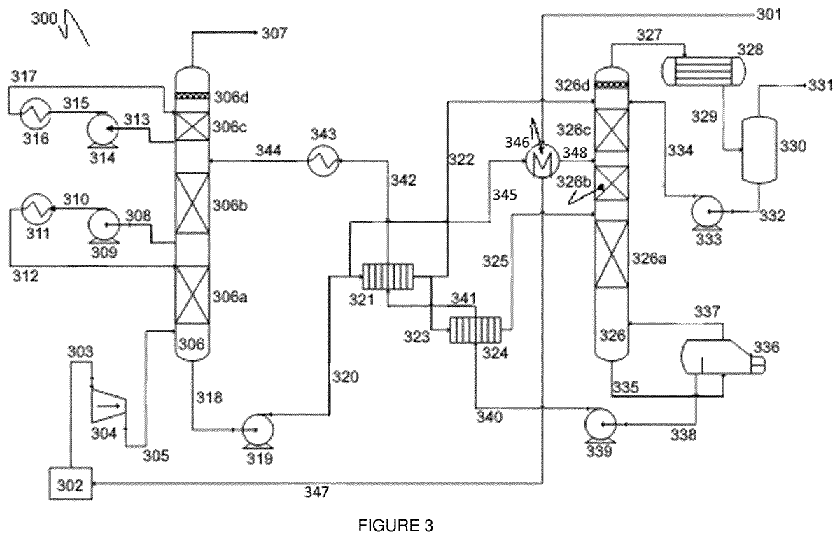

FIG. 3 is a schematic diagram of a system 300 according to the present invention that is used in capturing CO₂ from flue gases, wherein heat from a flue gas is used to heat a CO₂ rich solvent.

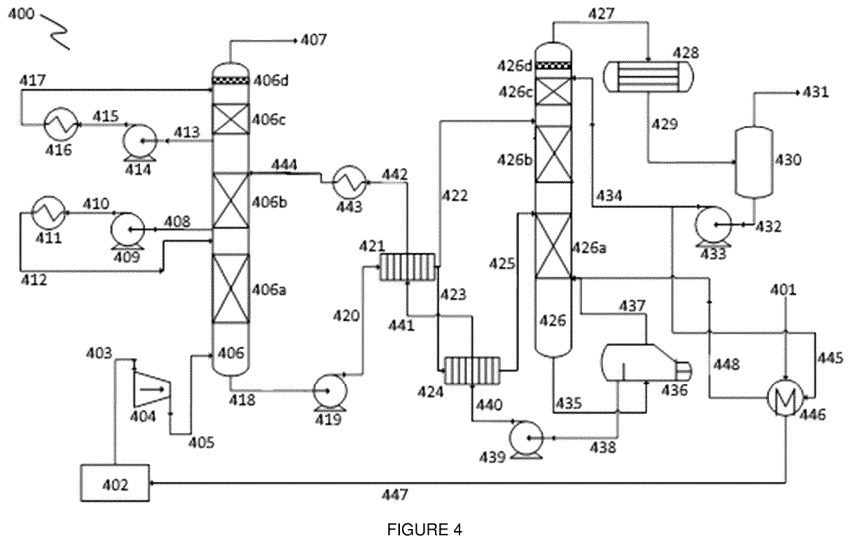

FIG. 4 is a schematic diagram of a system 400 according to the present invention that is used in capturing CO₂ from flue gases, wherein heat from a flue gas is used to heat a reflux condensate.

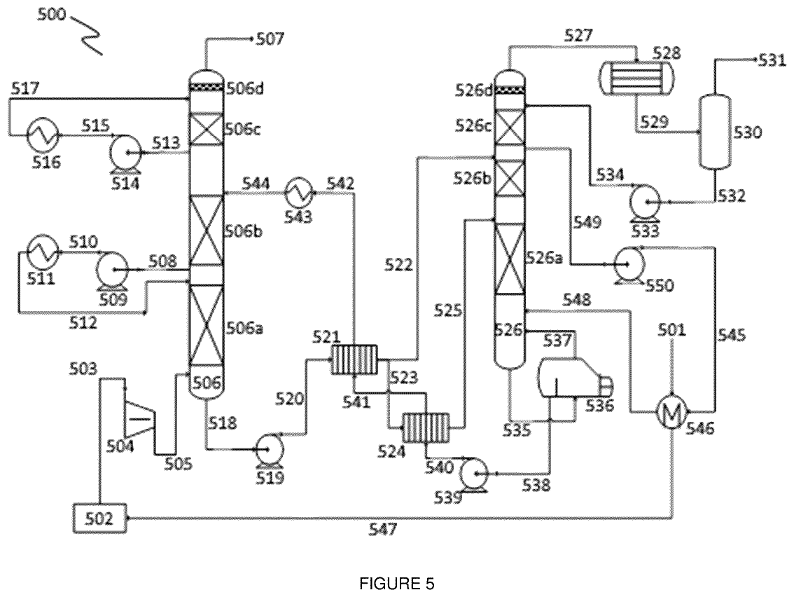

FIG. 5 is a schematic diagram of a system 500 according to the present invention that is used in capturing CO₂ from flue gases, wherein heat from a flue gas is used to heat a pre-heated reflux condensate.

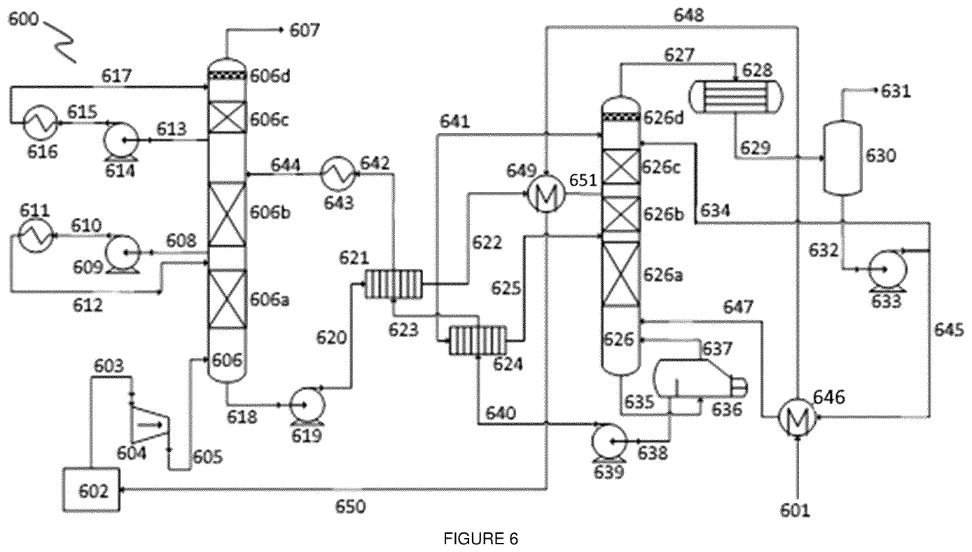

FIG. 6 is a schematic diagram of a system 600 according to the present invention that is used in capturing CO₂ from flue gases, wherein heat from a flue gas is used to heat a CO₂ rich solvent and a reflux condensate.

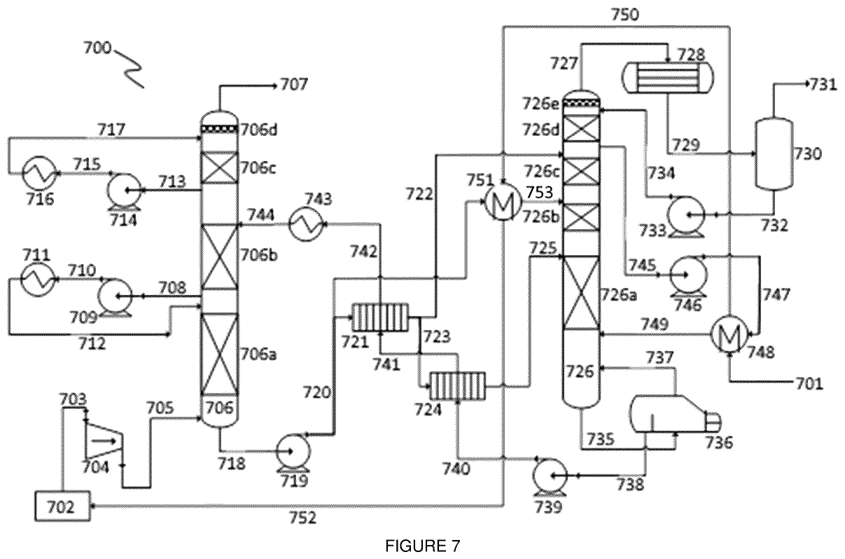

FIG. 7 is a schematic diagram of a system 700 according to the present invention that is used in capturing CO₂ from flue gases, wherein heat from a flue gas is used to heat a CO₂ rich solvent and a pre-heated reflux condensate.

Embodiments of the present disclosure will be described more fully hereinafter with reference to the accompanying drawings in which like numerals represent like elements throughout the several figures, and in which example embodiments are shown. Embodiments of the claims may, however, be embodied in many different forms and should not be construed as limited to the embodiments set forth herein.

The words “comprising,” “having,” “containing,” and “including,” and other forms thereof, are intended to be equivalent in meaning and be open ended in that an item or items following any one of these words is not meant to be an exhaustive listing of such item or items or meant to be limited to only the listed item or items. It must also be noted that as used herein and in the appended claims, the singular forms “a,” “an,” and “the” include plural references unless the context clearly dictates otherwise. Although any systems and methods similar or equivalent to those described herein can be used in the practice or testing of embodiments of the present disclosure, the preferred systems and methods are now described.

### Definitions

Some of the terms used to describe the present invention are set out below:

“Absorber” refers to a part of a system where components of a solvent (CO₂ lean solvent) uptake CO₂ from the gaseous phase to the liquid phase to form a CO₂ rich solvent. An absorber contains trays or packing (random or structured), which provides transfer area and intimate gas-liquid contact. The absorber may be a column. The absorber may be a static column or a Rotary Packed Bed (RPB). An absorber typically functions, in use, for example at a pressure of from 1 bar to 30 bar.

“CO₂ lean solvent” refers to solvent with a relatively low concentration of carbon dioxide. In a carbon dioxide capture method, a CO₂ lean solvent for contact with flue gases typically has a concentration of carbon dioxide from 0.0 to 0.7 mol L⁻¹.

“CO₂ rich solvent” refers to a solvent with a relatively high concentration of carbon dioxide. In a carbon dioxide capture method, the CO₂ rich solvent after contact with flue gases typically has a concentration of carbon dioxide of from 2 to 3.3 mol L⁻¹.

“Cool” when written with the term “solvent” refers to a solvent at a temperature of from 40 to 60° C.

“Cool” when written with the term “flue gas” refers to a flue gas at a temperature of from 30 to 55° C., preferably a temperature of from 40° C.

“Counter-current configuration” refers to a fluid moving in an opposite direction to another fluid. The fluids can be the same fluids or different fluids.

“Cross-over heat exchanger” refers to a part of the system where one liquid solvent is heated, whilst another liquid solvent is cooled, because the liquids are in thermal connection. For example, a liquid solvent (cool CO₂ rich solvent) can be heated from the heat of another liquid solvent (hot CO₂ lean solvent). A cross-over heat exchanger typically functions, in use, for example at a pressure of from 1 bar to 30 bar.

“Direct contact cooler” refers to a part of a system where a gas stream is cooled. Typically, the gas stream enters a direct contact cooler at a temperature of 100° C. and is cooled by contacting a recirculating loop of cool water in a packed bed or tray or spray type arrangement, for a better gas-liquid contact. Typically, the gas stream is cooled to a temperature of 40° C. Typically, the cool water is at a temperature of from 35 to 45° C., preferably 40° C.

“Flue gas” is a gas exiting to the atmosphere via a pipe or channel that acts as an exhaust from a boiler, furnace or a similar environment, for example a flue gas may be the emissions from power plants and other industrial activities that burn hydrocarbon fuel such as coal, gas and oil-fired power boilers, combined cycle power plants, coal gasification, hydrogen plants, biogas plants, waste to energy plants, steel plants, refineries, cement kilns, blast furnaces, or any other plant which produces a flue gas. A carbon dioxide rich flue gas is a flue gas that comprises carbon dioxide from 2.5 volume % to 51 volume %. Typically, this is the flue gas that enters the systems described in the present invention (e.g. flue gas 101, 201, 301, 401, 501, 601 and 701).

“Heat of absorption” refers to the relationship between the CO₂ loading of a carbon capture solvent and the components that form the carbon capture solvent. The heat of absorption increases with a decrease in CO₂ loading. Hence, increasing the CO₂ loading of the carbon capture solvent is an option for reducing the energy consumed in the regeneration of the carbon capture solvent, because the increase reduces the carbon capture solvent circulation rate.

“High-heat” when written with the term “solvent” refers to a solvent at a temperature of from 100 to 120° C., preferably at a temperature of 100 to 110° C.

“Hot” when written with the term “reflux condensate” refers to a reflux condensate at a temperature of from 110 to 130° C., or 120° C.

“Hot” when written with the term “vapour” refers to a temperature equal to or greater than 120° C., typically, in the range of from 120 to 180° C., or, from 120-130° C. Preferably, at a temperature of 120° C. Typically, the vapour is water vapour.

“Intensified solvent” refers to a solvent that can achieve a high CO₂ loading (optionally ≥3.0 mol/L) and forms a greater proportion of bicarbonate salts than carbamate salts. Examples of intensified solvents are included in US 2017/0274317 A1, the disclosure of which is incorporated herein by reference. An intensified solvent, in some embodiments, comprises: an alkanolamine, a reactive amine and a carbonate buffer.

“Latent heat of vapourisation of water” refers to the water vapourisation occurring at the same time as the CO₂ stripping from the carbon capture solvent. The water vapourisation will give heat away in the condenser.

“Low-heat” when written with the term “flue gas” refers to a flue gas at a temperature of from 55 to 80° C.

“Low-heat” when written with the term “solvent” refers to a solvent at a temperature of from 60 to 80° C.

“Medium heat” when written with the term “flue gas” refers to a flue gas at a temperature of from 80 to 110° C., preferably 90° C.

“Pre-heated” when written with the term “reflux condensate” refers to a reflux condensate at a temperature of from 90 to 110° C., preferably at a temperature of 100° C. Typically, the reflux condensate comprises water vapour.

“Reboiler” refers to a device that is used to provide heat at the bottom of a regenerator. Typically, the reboiler is used to boil a CO₂ lean solvent produced in a regenerator to generate a hot vapour which in turn is used in the regenerator.

“Regenerator” refers to a part of a system where heat (typically from heat vapour) is used to reverse the reaction between the liquid solvent and CO₂ to generate CO₂ and a solvent (the solvent being a CO₂ lean solvent). A regenerator operates in a temperature range of typically: from 60 to less than 140° C. Regeneration of a liquid solvent may be partial. A regenerator may be a static column or a Rotary Packed Bed (RPB). A regenerator typically functions, in use, for example at a pressure of from 0.2 bar to 5.0 bar.

“Reflux condensate” refers to a liquid formed from water vapours which have undergone condensation. Typically, the water vapours are produced in a regenerator.

“Rotary Packed Bed (RPB)” refers to an absorber or a regenerator where the packing is housed in a rotatable disk (rather than in a static bed, as in a static column), which can be rotated at high speed to generate a high gravity centrifugal force within the RPB.

“Sensible heat” refers to the difference between the change in temperature in which the carbon capture solvent undergoes during the regeneration process compared to the change in temperature in which the carbon capture solvent undergoes upon maintaining a sufficient minimum temperature approach. The difference in temperature is caused by heat being lost to cooling water in a lean solvent cooler. The temperature difference can be applied with external heat.

“Solvent” refers to an absorbent. The solvent may be a liquid. The solvent may be an intensified solvent. Optionally, the intensified solvent comprises a tertiary amine, a secondary amine, or, a primary amine. Optionally, the intensified solvent may further comprise tertiary amine, a sterically hindered amine, a polyamine, a salt and water. Optionally, the intensified solvent comprises a tertiary amine, a sterically hindered amine, a polyamine, a salt and water. Optionally, the tertiary amine in the intensified solvent is one or more of: N-methyl-diethanolamine (MDEA) or Triethanolamine (TEA). Optionally, the sterically hindered amines in the intensified solvent are one or more of: 2-amino-2-ethyl-1,3-propanediol (AEPD), 2-amino-2-hydroxymethyl-1,3-propanediol (AHPD) or 2-amino-2-methyl-1-propanol (AMP). Optionally, the polyamine in the intensified solvent is one or more of: 2-piperazine-1-ethylamine (AEP) or 1-(2-hydroxyethyl) piperazine. Optionally, the salt in the intensified solvent is potassium carbonate. Optionally, water (for example, deionised water) is included in the solvent so that the solvent exhibits a single liquid phase. Optionally, the solvent is CDRMax as sold by Carbon Clean Solutions Limited. CDRMax, as sold by Carbon Clean Solutions Limited, has the following formulation: from 15 to 25 weight % 2-amino-2-methyl propanol (CAS number 124-68-5); from 15 to 25 weight % 1-(2-ethylamino) piperazine (CAS number 140-31-8); from 1 to 3 weight % 2-methylamino-2-methyl propanol (CAS number 27646-80-6); from 0.1 to 1 weight % potassium carbonate (584-529-3); and, the balance being deionised water (CAS number 7732-18-5). Optionally, the solvent is MEA (monoethanolamine).

“Static column” refers to a part of a system used in a separation method. It is a hollow column with internal mass transfer devices (e.g., trays, structured packing, random packing). A packing bed may be structured or random packing which may contain catalysts or adsorbents.

“Stripper condenser” refers to a device that is used to cool CO₂ and water vapour from the top of the regenerator. Typically, the stripper condenser is used to cool the CO₂ and water vapour from the top of the regenerator to condense the water vapour.

“Weight %” refers to the percentage, by total weight, of a particular component within a mixture of components.

### EXAMPLES

The following are non-limiting examples that discuss, with reference to tables and figures, the advantages of the present invention. The examples set forth herein are non-limiting examples and are merely examples among other possible examples.

### System 300: a System and Method of the Present Invention

FIG. 3 illustrates a schematic diagram of a system 300 for capturing CO₂ from flue gases. In the system 300 for capturing CO₂ from flue gases shown in FIG. 3, CO₂ is separated from a mixture of gases using a solvent (initially a CO₂ lean solvent), which selectively reacts with the CO₂ (to form a CO₂ rich solvent). After the CO₂ has reacted with the solvent (CO₂ lean solvent), the solvent (CO₂ rich solvent) can be regenerated (to CO₂ lean solvent) using heat to release the CO₂ and regenerate the solvent for further CO₂ processing.

As shown in FIG. 3 (indicating a system of the present invention), a flue gas 301 containing CO₂ enters the system 300. The temperature of the flue gas 301 when entering the system 300 is typically greater than 100° C., typically from 120 to 200° C. The flue gas 301 is cooled to from 30 to 50° C., or 40° C. before the flue gas 301 enters the absorber 306.

Firstly, the flue gas 301 passes through a first heat exchanger 346. The first heat exchanger 346 is preferably a flue gas rich solvent exchanger. In the first heat exchanger 346, the flue gas is cooled to form low-heat flue gas 347 and the heat from the flue gas 301 is used to heat a cool, CO₂ rich solvent 345 to form a low-heat CO₂ rich solvent 348. Typically, the low-heat flue gas 347 is at a temperature of 55 to 80° C., preferably 75° C. Typically, the low-heat CO₂ rich solvent 348 is at a temperature of from 60 to 80° C., preferably 75° C.

The low-heat flue gas 347 optionally passes through a flue gas pre-treatment section 302. In the flue gas pre-treatment section 302, the low-heat flue gas 347 passes through a direct contact cooler. In the direct contact cooler, the low-heat flue gas 347 is contacted with a recirculating loop of cool water in a counter-current configuration. Through this contact, the low-heat flue gas 347 is cooled. The cooled flue gas forms flue gas 303, which is cooled to a temperature of typically 40° C. Optionally, through contact with an alkali solution, SO₂ and NO₂ are removed from the low-heat flue gas 347. The flue gas 303 then passes through a booster fan 304 to form flue gas 305. The booster fan 304 increases the pressure of the flue gas 303 to compensate for the pressure drop through the system 300, thereby ensuring that the pressure of the resultant CO₂ lean flue gas (flue gas 307) is at the same pressure as flue gas 301, or just above at a pressure of 5 mbar. Upon leaving the booster fan 304, flue gas 305 is formed.

The flue gas 305 enters the absorber 306 below packing 306a, where the flue gas 305 is counter-currently contacted with a cool, CO₂ lean solvent 344. The cool, CO₂ lean solvent 344 is typically at a temperature of 40° C. The flue gas 305 rises through the absorber 306. The cool, CO₂ lean solvent 344 enters the absorber 306 via a liquid distributor (not shown in FIG. 3). And then enters the absorber 306 between packing 306b and 306c, and cascades down through the absorber 306. The absorber 306 contains packing to maximise the surface area to volume ratio: the packing is shown by references 306a, 306b and 306c in FIG. 3. To maintain the temperature of the absorber 306, the location of the packing (the intercooling sections) and the height of each packing will be optimised on a case-to-case basis. Once the cool, CO₂ lean solvent 344 has passed through packing 206b, a cool, CO₂ lean solvent 308 is formed and the cool, CO₂ lean solvent 308 passes to an absorber interstage pump 309 forming cool, CO₂ lean solvent 310. Approximately, 90 to 100% of the cool, CO₂ lean solvent 344 passes through the interstage pump 309 to form cool, CO₂ lean solvent 310, instead of passing directly down through the absorber 306. The cool, CO₂ lean solvent 344 that passes through the interstage pump 309 is labelled 308 in FIG. 3. The absorber interstage pump 309 is used to feed the cool, CO₂ lean solvent 310 back into the absorber 306. The cool, CO₂ lean solvent 310 then passes to an absorber interstage cooler 311 forming cool, CO₂ lean solvent 312. The absorber interstage cooler 311 removes any excess heat from the solvent during the exothermic CO₂ absorption reaction. The cool, CO₂ lean solvent 312 then continues to cascade through absorber 306. The active components in the cool, CO₂ lean solvent 312 react with the CO₂ in the cool flue gas 305. Advantageously, by cooling part of the cool, CO₂ lean solvent the temperature of the cool, CO₂ lean solvent is reduced in the bottom section of the absorber 306 (i.e., in the section below packing 306b). A cool, CO₂ lean solvent with a reduced temperature has an increased loading of CO₂, which in turn reduces the heat of absorption energy required by the absorber 306.

When the cool, CO₂ lean solvent 312 reaches the bottom of the absorber 306, it is rich in CO₂ and forms cool, CO₂ rich solvent 318. Typically, the cool, CO₂ rich solvent 318 is at a temperature of 40° C.

As the cool flue gas 305 passes up through the absorber 306, it is depleted of CO₂ and eventually forms CO₂ lean flue gas 307. When the cool flue gas 305 has passed through packing 306b, a CO₂ lean flue gas is formed. The CO₂ lean flue gas passes through a water wash packing 306c to recover any solvent present in the CO₂ lean flue gas. The wash water 313 passes through a water wash pump 314 which provides sufficient pressure to feed the wash water 313 back into the absorber 306. Once the wash water 313 has passed through the wash water pump 314, wash water 315 is formed. Wash water 315 passes through a water wash cooler 316 to form wash water 317. The water wash cooler 316 is required to cool the CO₂ lean flue gas 306c to recover water and any solvent present. The wash water 317 then enters the absorber 306 and passes down the absorber 306 and withdrawn as wash water 313 at the bottom of packing 306c. Once the flue gas has been washed, the flue gas continues to pass up through the absorber 306. The CO₂ lean flue gas is released from the top of the absorber 306 as CO₂ lean flue gas 307. The absorber 306 further includes a demister 306d, through which the CO₂ lean flue gas passes through before leaving the absorber 306. The demister 306d is used to enhance the removal of liquid droplets from the flue gas.

The cool, CO₂ rich solvent 318 passes through a solvent pump 319 to form cool, CO₂ rich solvent 320. Typically, the cool, CO₂ rich solvent 320 is at a temperature of 40° C. Then the cool, CO₂ rich solvent 320 is regenerated in regenerator 326 to reform cool, CO₂ lean solvent 344. The solvent pump 319 is used to overcome the pressure loss of the cool, CO₂ rich solvent 318 on the path to the regenerator 326. The regenerator 326 contains packing to maximise the surface area to volume ratio: the packing is shown by references 326a, 326b and 326c, and a demister is shown by reference 326d in FIG. 3. The packing 326a is present in the half of the regenerator 326 connected to a reboiler 336, this is the bottom of the regenerator 326. The packing 326c is present in the half of the regenerator 326 connected to a condenser 328, this part is the top of the regenerator 326. Packing 326b is present between packing 326a and packing 326c. The packing is placed in the specific locations in the regenerator 326 to maintain the required temperature profile in the regenerator 326.

The cool, CO₂ rich solvent 320 enters the regenerator 326 via one of three pathways.

Firstly, the cool, CO₂ rich solvent 320 is split into two streams. One stream, cool CO₂ rich solvent 345, enters the first heat exchanger 346. Typically, the cool, CO₂ rich solvent 345 is at a temperature of 40° C. In the first heat exchanger 346, the cool CO₂ rich solvent 345 is heated with heat from flue gas 301 to form low-heat CO₂ rich solvent 348. Typically, the low-heat CO₂ rich solvent 348 is at a temperature of from 60 to 80° C., preferably at a temperature of 75° C. The low-heat CO₂ rich solvent 348 enters the regenerator 326 between packing section 326b and 326c and cascades down the regenerator 326. By using heat from the flue gas 301 to heat the cool CO₂ rich solvent 345, the amount of energy required by the regenerator 326 to heat the CO₂ rich solvent is reduced.

Secondly, the second stream of the cool, CO₂ rich solvent 320 enters a cross-over heat exchanger 321. In the cross-over heat exchanger 321, the cool, CO₂ rich solvent 320 is heated by a low-heat, CO₂ lean solvent 341 to form a low-heat, CO₂ rich solvent. Typically, the low-heat, CO₂ lean solvent 341 is at a temperature of from 60 to 80° C., preferably at a temperature of from 70 to 80° C., preferably temperature of 70° C. Typically, the low-heat, CO₂ rich solvent is at a temperature of from 60 to 80° C., preferably at a temperature of from 60 to 70° C., preferably at a temperature of 60° C. The cross-over heat exchanger 321 helps to reduce the heat lost from the CO₂ lean solvent in a cooler 343 further downstream: by minimising the heat lost at this stage, the amount of sensible heat required to regenerate the carbon capture solvent is reduced.

The low-heat CO₂ rich solvent is split into two streams: low-heat, CO₂ rich solvent 322 and low-heat, CO₂ rich solvent 323. Typically, the split is 10-40 weight % to low-heat, CO₂ rich solvent 322 and 60 to 90% to low-heat, CO₂ rich solvent 323.

The low-heat, CO₂ rich solvent 322 enters the regenerator 326 between packing 326c and the demister 326d and cascades down the regenerator 326. By providing the low-heat CO₂ rich solvent 322 between packing 326c and 326d of the regenerator, (instead of providing one total high-heat CO₂ rich solvent to the regenerator 326), the heat of water vapourisation can be recovered from the water vapour leaving at the top of the regenerator 326 passing heat to the low-heat CO₂ rich solvent 322. This reduces the heat going to a stripper condenser 328, and thus decreases the heat required inside regenerator 326.

The low-heat, CO₂ rich solvent 323 passes to a cross-over heat exchanger 324. In the cross-over heat exchanger 324, the low-heat, CO₂ rich solvent 323 is heated by a high-heat, CO₂ lean solvent 340 to form a high-heat, CO₂ rich solvent 325. Typically, the high-heat, CO₂ lean solvent 340 is at a temperature of from 100 to 120° C., preferably at a temperature of 120° C. Typically, the high-heat CO₂ rich solvent 325 is at a temperature of from 100 to 120° C., preferably at a temperature of 110° C. The high-heat, CO₂ rich solvent 325 enters the regenerator 326 between packing 326a and 326b and cascades down the regenerator 326.

Inside the regenerator 326, water vapourisation and CO₂ stripping from the CO₂ rich solvent occurs. Advantageously, by providing a low-heat, CO₂ rich solvent 322, a low-heat CO₂ rich solvent 348 and a high-heat, CO₂ rich solvent 325, a low temperature at the top of the regenerator 326 (i.e., above packing 326b) can be achieved, and a high temperature at the bottom of the regenerator 326 (i.e., below packing 326b) can be achieved. By maintaining a high temperature at the bottom of the regenerator 326, the reaction between the active components in the carbon capture solvent and CO₂ can be reversed. By maintaining a low temperature at the top of the regenerator 326, the heat of water vapourisation can be recovered by any water vapour present at the top of the regenerator 326 passing heat to the low-heat CO₂ rich solvent 322.

Inside the regenerator 326, the low-heat, CO₂ rich solvent 322, low-heat CO₂ rich solvent 348 and high-heat, CO₂ rich solvent 325 are heated through contact with hot vapour 337. Typically, the hot vapour 337 flows upwards through the regenerator 326, counter-currently to the high-heat, CO₂ rich solvent 322, low-heat CO₂ rich solvent 348 and high-heat, CO₂ rich solvent 325. Upon heating, the reaction between the active components of the solvents and CO₂ reverses, releasing CO₂ and water vapour 327 and forming a high-heat, CO₂ lean solvent 335.

The CO₂ and water vapour 327 passes to a stripper condenser 328 operating at a temperature of from 35 to 40° C. The stripper condenser 328 forms a condensate 329 from the water vapour, which passes to a reflux drum 330 to form reflux condensate 332. The reflux drum 332 separates gaseous CO₂ 331 and the reflux condensate 332. The reflux condensate 332 then passes to a reflux pump 333 to form reflux condensate 334. The reflux pump 333 is used to move the reflux condensate 334 back into the regenerator 326. The reflux condensate 334 then passes back into the regenerator 326 between packing 326c and demister 326d. Having passed through the stripper condenser 328, the condensate 329 and the subsequently formed reflux condensate 332 and reflux condensate 334 are at a temperature of from 35 to 40° C.

A gaseous CO₂ 331 is formed in the reflux drum 330. The gaseous CO₂ 331 is the CO₂ product stream and can be used in downstream processes.

The high-heat, CO₂ lean solvent 335 is fed into a reboiler 336. Typically, the reboiler 336 is operating at a temperature of from 120° C. or greater, preferably at a temperature of 120° C. Within the reboiler 336, the high-heat, CO₂ lean solvent 335 is boiled using steam or any other hot medium resulting in the formation of a hot vapour 337 and high-heat, CO₂ lean solvent 338. Typically, the hot vapour 337 is at a temperature of from 120° C. or greater, preferably at a temperature of 120° C. Typically, the hot vapour 337 comprises CO₂ and water vapour. The hot vapour 337 is used in the regenerator 326 and enters the regenerator below packing 326a. Typically, the high-heat, CO₂ lean solvent 338 is at a temperature of 100 to 120° C., preferably at a temperature of 120° C.

The high-heat, CO₂ lean solvent 338 passes to a solvent pump 339 to form high-heat, CO₂ lean solvent 340. The solvent pump 339 is used to move the high-heat, CO₂ lean solvent 338 to the cross-over heat exchanger 324. The high-heat, CO₂ lean solvent 340 then passes to the cross-over heat exchanger 324. In the cross-over heat-exchanger 324, the high-heat, CO₂ lean solvent 340 is cooled to form low-heat, CO₂ lean solvent 341. The low-heat, CO₂ lean solvent 341 then passes to the cross-over heat exchanger 321. In the cross-over heat-exchanger 321, the low-heat, CO₂ lean solvent 341 is cooled by exchanging heat with cool, CO₂ rich solvent 320 to form cool, CO₂ lean solvent 342. Typically, the cool, CO₂ lean solvent 342 is at a temperature of from 40 to 60° C., preferably at a temperature of 55° C. The cool, CO₂ lean solvent 342 passes to a solvent pump 343 to form cool, CO₂ lean solvent 344. In the cooler 343, the cool, CO₂ lean solvent 342 is cooled to 40° C. to form cool, CO₂ lean solvent 344. Cool, CO₂ lean solvent 344 is ready to enter absorber column 306.

Advantageously, by using the heat from the flue gas 301 to heat cool, CO₂ rich solvent 320, heat can be recovered from the flue gas 301 and therefore the amount of heat and steam required for the solvent regeneration is reduced. Thus, energy and therefore also costs, are reduced.

Further advantageously, the flue gas 301 is cooled and therefore the load on the flue-gas pre-treatment 302, and in particular the direct contact cooler, is reduced. Thus, the equipment size would be smaller.

### System 400: a System and Method of the Present Invention

FIG. 4 illustrates a schematic diagram of a system 400 for capturing CO₂ from flue gases. In the system 400 for capturing CO₂ from flue gases shown in FIG. 4, CO₂ is separated from a mixture of gases using a solvent (initially a CO₂ lean solvent), which selectively reacts with the CO₂ (to form a CO₂ rich solvent). After the CO₂ has reacted with the solvent (CO₂ lean solvent), the solvent (CO₂ rich solvent) can be regenerated (to CO₂ lean solvent) using heat to release the CO₂ and regenerate the solvent for further CO₂ processing.

As shown in FIG. 4 (indicating a system of the present invention), a flue gas 401 containing CO₂ enters the system 400. The temperature of the flue gas 401 when entering the system 400 is typically greater than 100° C., typically from 120 to 200° C. The flue gas 401 is cooled to from 30 to 50° C., or 40° C. before the flue gas 401 enters the absorber 406.

Firstly, the flue gas 401 passes through a first heat exchanger 446. The first heat exchanger is preferably a flue gas rich solvent exchanger. In the first heat exchanger 446, the flue gas is cooled to form medium-heat flue gas 447 and the heat from the flue gas 401 is used to heat a reflux condensate 445 to form a hot vapour 448. Typically, the medium-heat flue gas 447 is at a temperature of 80 to 110° C., preferably 90° C. Typically, the hot vapour 448 is at a temperature of from 110 to 130° C., preferably 120° C.

The medium-heat flue gas 447 optionally passes through a flue gas pre-treatment section 402. In the flue gas pre-treatment section 402, the medium-heat flue gas 447 passes through a direct contact cooler. In the direct contact cooler, the medium-heat flue gas 447 is contacted with a recirculating loop of cool water in a counter-current configuration. Through this contact, the medium-heat flue gas 447 is cooled. The cooled flue gas forms flue gas 403, which is cooled to a temperature of typically 40° C. Optionally through contact with an alkali solution the SO₂ and NO₂ are removed from the medium-heat flue gas 447. The flue gas 403 then passes through a booster fan 404. The booster fan 404 increases the pressure of the flue gas 403 to compensate for the pressure drop through the system 400, thereby ensuring that the pressure of the resultant CO₂ lean flue gas (flue gas 407) is at the same pressure as flue gas 401, or just above at a pressure of 5 mbar. Upon leaving the booster fan 304, flue gas 405 is formed.

The flue gas 405 enters the absorber 406, where the flue gas 405 is contacted with a cool, CO₂ lean solvent 444 in a counter-current configuration. The cool, CO₂ lean solvent 444 is typically at a temperature of 40° C. The flue gas 405 rises through the absorber 406. The cool, CO₂ lean solvent 444 enters the absorber 406 via a liquid distributor (not shown in FIG. 4), and then enters the absorber 406 at the top of packing 406b and cascades down through the absorber 406. The absorber 406 contains packing to maximise the surface area to volume ratio: the packing is shown by references 406a, 406b and 406c in FIG. 4. To maintain the temperature of the absorber 406, the location of the packing (the intercooling sections) and the height of each packing will be optimised on a case-to-case basis. Once the cool, CO₂ lean solvent 444 has passed through packing 406b, a cool, CO₂ lean solvent 408 is formed and the cool, CO₂ lean solvent 408 passes to an absorber interstage pump 409 forming cool, CO₂ lean solvent 410. Approximately, 90 to 100% of the cool, CO₂ lean solvent 444 passes through the interstage pump 409 to form cool, CO₂ lean solvent 410, instead of passing directly down through the absorber 406. The cool, CO₂ lean solvent 444 that passes through the interstage pump 409 is labelled 408 in FIG. 4. The absorber interstage pump 409 is used to feed the cool, CO₂ lean solvent 410 back into the absorber 406. The cool, CO₂ lean solvent 410 then passes to an absorber interstage cooler 411 forming cool, CO₂ lean solvent 412. The absorber interstage cooler 411 removes any excess heat from the solvent during the exothermic CO₂ absorption reaction. The cool, CO₂ lean solvent 412 then continues to cascade through absorber 406. The active components in the cool, CO₂ lean solvent 412 react with the CO₂ in the cool flue gas 405. Advantageously, by cooling part of the cool, CO₂ lean solvent the temperature of the cool, CO₂ lean solvent is reduced in the bottom section of the absorber 406 (i.e., in the section below packing 406b. A cool, CO₂ lean solvent with a reduced temperature will increase the loading of CO₂ into the cool, CO₂ lean solvent, which in turn reduces the heat of absorption energy required by the absorber 406.

When the cool, CO₂ lean solvent 412 reaches the bottom of the absorber 406, it is rich in CO₂ and forms cool, CO₂ rich solvent 418. Typically, cool, CO₂ rich solvent 418 is at a temperature of 40° C.

As the cool flue gas 405 passes up through the absorber 406, it is depleted of CO₂ and eventually forms CO₂ lean flue gas 407. When the cool flue gas 405 has passed through packing 406b, a CO₂ lean flue gas is formed. The CO₂ lean flue gas passes through a water wash packing 406c to recover any solvent present in the CO₂ lean flue gas. The wash water 413 passes through a water wash pump 414 which provides sufficient pressure to feed the wash water 413 back into the absorber 406. Once the wash water 413 has passed through the wash water pump 414, wash water 415 is formed. Wash water 415 passes through a water wash cooler 416 to form wash water 417. The water wash cooler 416 is required to cool the CO₂ lean flue gas to recover water and any solvent present. The wash water 417 then enters the absorber 406 and passes down the absorber 406 and is withdrawn as wash water 413 at the bottom of packing 406c. Once the flue gas 405 has been washed, the flue gas continues to pass up through the absorber 406. The CO₂ lean flue gas is released from the top of the absorber 406 as CO₂ lean flue gas 407. The absorber 406 further includes a demister 406d, through which the CO₂ lean flue gas passes through before leaving the absorber 406. The demister 406d is used to enhance the removal of liquid droplets from the flue gas.

The cool, CO₂ rich solvent 418 passes through a solvent pump 419 to form cool, CO₂ rich solvent 420. Typically, cool, CO₂ rich solvent 418 is at a temperature of 40° C. Then the cool, CO₂ rich solvent 420 is regenerated in regenerator 426 to reform cool, CO₂ lean solvent 444. The solvent pump 419 is used to overcome the pressure loss of the cool, CO₂ rich solvent 418 on the path to the regenerator 426. The regenerator 426 contains packing to maximise the surface area to volume ratio: the packing is shown by references 426a, 426b and 426c, and a demister is shown by reference 426d in FIG. 4. The packing 426a is present in the half of the regenerator 426 connected to a reboiler 436, this part is the bottom of the regenerator 426. The packing 426c is present in the half of the regenerator 426 connected to a condenser 428, this part is the top of the regenerator 426. Packing 426b is present between packing 426a and packing 426c. The packing is placed in the specific locations in the regenerator 426 to maintain the required temperature profile in the regenerator 426.

The cool, CO₂ rich solvent 420 enters the regenerator 426 via one of two pathways.

The cool, CO₂ rich solvent 420 enters a cross-over heat exchanger 421. In the cross-over heat exchanger 421, the cool, CO₂ rich solvent 420 is heated by a low-heat, CO₂ lean solvent 441 to form a low-heat, CO₂ rich solvent. Typically, the low-heat, CO₂ lean solvent 441 is at a temperature of from 60 to 80° C., preferably at a temperature of from 70 to 80° C., preferably at a temperature of 70° C. Typically, the low-heat, CO₂ rich solvent is at a temperature of from 60 to 80° C., preferably at a temperature of from 60 to 70° C., preferably at a temperature of 60° C. The cross-over heat exchanger 421 helps to reduce the heat lost from the CO₂ lean solvent in a cooler 443 further downstream: by minimising the heat lost at this stage, the amount of sensible heat required to regenerate the carbon capture solvent is reduced.

The low-heat CO₂ rich solvent is split into two streams: low-heat, CO₂ rich solvent 422 and low-heat, CO₂ rich solvent 423. Typically, the split is 10-40 weight % to low-heat, CO₂ rich solvent 422 and 60 to 90% to low-heat, CO₂ rich solvent 423.

The low-heat, CO₂ rich solvent 422 enters the regenerator 426 between packing 426b and 426c, and cascades down the regenerator 426. By providing the low-heat CO₂ rich solvent 422 between packing 426b and 426c of the regenerator 426 (instead of a high-heat CO₂ rich solvent), the heat of water vapourisation can be recovered by any water vapour present at the top of the regenerator 426 passing heat to the low-heat CO₂ rich solvent 422.

The low-heat, CO₂ rich solvent 423 passes to a cross-over heat exchanger 424. In the cross-over heat exchanger 424, the low-heat, CO₂ rich solvent 423 is heated by a high-heat, CO₂ lean solvent 440 to form a high-heat, CO₂ rich solvent 425. Typically, the high-heat, CO₂ lean solvent 440 is at a temperature of from 100 to 125° C., preferably at a temperature of 120° C. Typically, the high-heat CO₂ rich solvent 425 is at a temperature of from 100 to 120° C., preferably at a temperature of 110° C. The high-heat, CO₂ rich solvent 425 enters the regenerator 426 at the top of packing section 426a and cascades down the regenerator 426.

Inside the regenerator 426, water vapourisation and CO₂ stripping from the CO₂ rich solvent occurs. Advantageously, by providing a low-heat, CO₂ rich solvent 422 and a high-heat, CO₂ rich solvent 425, a low temperature at the top of the regenerator 426 (i.e., above packing 426b) can be achieved, and a high temperature at the bottom of the regenerator 426 (i.e., below packing 426b) can be achieved. By maintaining a high temperature at the bottom of the regenerator 426, the reaction between the active components in the carbon capture solvent and CO₂ can be reversed. By maintaining a low temperature at the top of the regenerator 426, the heat of water vapourisation can be recovered by any water vapour present at the top of the regenerator 426 passing heat to the low-heat CO₂ rich solvent 422.

Inside the regenerator 426, the low-heat, CO₂ rich solvent 422 and high-heat, CO₂ rich solvent 425 are heated through contact with hot vapour 437. Typically, the hot vapour 437 flows upwards through the regenerator 426, counter-currently to the low-heat, CO₂ rich solvent 422 and high-heat, CO₂ rich solvent 425. Upon heating, the reaction between the active components of the solvents and CO₂ reverses, releasing CO₂ and water vapour 427 and forming a high-heat, CO₂ lean solvent 435.

The CO₂ and water vapour 427 passes to a stripper condenser 428 operating at a temperature of from 35 to 40° C. The stripper condenser 428 forms a condensate 429 from the water vapour, which passes to a reflux drum 430 to form reflux condensate 432. The reflux drum 430 separates gaseous CO₂ 431 and the reflux condensate 432. A gaseous CO₂ 431 is formed in the reflux drum 430. The gaseous CO₂ 431 is the CO₂ product stream and can be used in downstream processes. The reflux condensate 432 then passes to a reflux pump 433 to form reflux condensate 434 and reflux condensate 445. The reflux pump 433 is used to move the reflux condensate 434 back into the regenerator 426. Having passed through the stripper condenser 428, the condensate 429 and the subsequently formed reflux condensate 432 and reflux condensate 434 are at a temperature of from 35 to 40° C.

The reflux condensate is split into two streams: reflux condensate 434 which passes into the regenerator 426 at the top of packing section 426c, and reflux condensate 445. Reflux condensate 445 passes through the first heat exchanger 446 to be heated by the flue gas 401. Upon heating the reflux condensate 445 in the first heat exchanger 446, hot vapour 448 is formed. Typically, the hot vapour 448 is at a temperature of from 115 to 130° C., preferably at a temperature of from 120 to 130° C. The hot vapour 448 enters the regenerator 426 at the bottom of packing section 426a. Advantageously, when the hot vapour 448 enters the regenerator 426 at the bottom of packing section 426a, the high temperature required at or near the bottom of the regenerator 426 can be maintained, advantageously reducing the amount of energy required by system 400 as well as reducing the cost required to regenerate the cool, CO₂ lean solvent 444, by reducing the size of the reboiler 436. For example, the hot vapour 448 helps to heat low-heat, CO₂ rich solvent 422 and high-heat, CO₂ rich solvent 425. Furthermore, the flue gas 401 reduces the heat duty required and equipment size required to cool the flue gas 401 to form flue gas 403 (which is typically at a temperature of 40° C.).

The high-heat, CO₂ lean solvent 435 is fed into a reboiler 436. Typically, the reboiler 436 is operating at a temperature of 120° C. or greater, preferably at a temperature of 120° C. Within the reboiler 436, the high-heat, CO₂ lean solvent 435 is boiled using steam or any other hot medium resulting in the formation of hot vapour 437 and high-heat, CO₂ lean solvent 438. Typically, the hot vapour 437 is at a temperature of from 120° C. or greater, preferably at a temperature of 120° C. Typically, the hot vapour 437 comprises CO₂ and water vapour. The hot vapour 437 is used in the regenerator 426 and enters the regenerator at the bottom of packing section 426a. Typically, the high-heat, CO₂ lean solvent 438 is at a temperature of from 100 to 120° C., preferably at a temperature of 120° C.

The high-heat, CO₂ lean solvent 438 passes to a solvent pump 439 to form high-heat, CO₂ lean solvent 440. The solvent pump 439 is used to move the high-heat, CO₂ lean solvent 438 to the cross-over heat exchanger 424. The high-heat, CO₂ lean solvent 440 then passes to the cross-over heat exchanger 424. In the cross-over heat-exchanger 424, the high-heat, CO₂ lean solvent 440 is cooled to form low-heat, CO₂ lean solvent 441. The low-heat, CO₂ lean solvent 441 then passes to the cross-over heat exchanger 421. In the cross-over heat-exchanger 421, the low-heat, CO₂ lean solvent 441 is cooled by exchanging heat with cool, CO₂ rich solvent 420 to form cool, CO₂ lean solvent 442. Typically, the cool, CO₂ lean solvent 442 is at a temperature of from 40 to 60° C., preferably at a temperature of 55° C. The cool, CO₂ lean solvent 442 passes to a cooler 443 to form cool, CO₂ lean solvent 444. In the cooler 443, the cool, CO₂ lean solvent 342 is cooled to 40° C. to form cool, CO₂ lean solvent 444. Cool, CO₂ lean solvent 444 is ready to enter absorber column 406.

Advantageously, by using the heat from the flue gas 401 to heat the reflux condensate 445, heat can be recovered from the flue gas 401 and therefore the amount of heat and steam required for the solvent regeneration is reduced. Thus, energy and therefore also costs, are reduced.

Further advantageously, by using heat from the flue gas 401 to heat the reflux condensate 445, heat recovery on the cross-over heat exchangers 421 and 424 is not limited, thereby maximising the heat that can be recovered from the flue gas 401.

Further advantageously, by using heat from the flue gas 401, the load on the flue gas cooling part of the system 400 (i.e., the direct contact cooler in flue gas pre-treatment section 402) is reduced and as a result the equipment size of the equipment used in the flue gas cooling part of the system 400 can be reduced. Thus, the equipment size would be smaller.

### System 500: a System and Method of the Present Invention

FIG. 5 illustrates a schematic diagram of a system 500 for capturing CO₂ from flue gases. In the system 500 for capturing CO₂ from flue gases shown in FIG. 5, CO₂ is separated from a mixture of gases using a solvent (initially a CO₂ lean solvent), which selectively reacts with the CO₂ (to form a CO₂ rich solvent). After the CO₂ has reacted with the solvent (CO₂ lean solvent), the solvent (CO₂ rich solvent) can be regenerated (to CO₂ lean solvent) using heat to release the CO₂ and regenerate the solvent for further CO₂ processing.

As shown in FIG. 5 (indicating a system of the present invention), a flue gas 501 containing CO₂ enters the system 500. The temperature of the flue gas 501 when entering the system 500 is typically greater than 100° C., typically from 120 to 200° C. The flue gas 501 is cooled to from 30 to 50° C., or 40° C. before the flue gas 501 enters the absorber 506.

Firstly, the flue gas 501 passes through a first heat exchanger 546. The first heat exchanger 546 is preferably a flue gas rich solvent exchanger. In the first heat exchanger 546, the flue gas is cooled to form a medium-heat flue gas 547 and the heat from the flue gas 501 is used to heat a pre-heated reflux condensate 545 to form a hot vapour 548. Typically, the pre-heated reflux condensate 545 is at a temperature of from 60 to 90° C., preferably 70° C. The hot vapour 548 is made from water vapour. Typically, the hot vapour 548 is at a temperature of from 110 to 130° C., preferably 120° C. Typically, the medium-heat flue gas 547 is at a temperature of 80 to 110° C., preferably 90° C.

The medium-heat flue gas 547 optionally passes through a flue gas pre-treatment section 502. In the flue gas pre-treatment section 502, the medium-heat flue gas 547 passes through a direct contact cooler. In the direct contact cooler, the medium-heat flue gas 547 is contacted with a recirculating loop of cool water in a counter-current configuration. Through this contact, the medium-heat flue gas 547 is cooled. The cooled flue gas forms flue gas 503, which is cooled to a temperature of typically 40° C. Optionally through contact with an alkali solution the SO₂ and NO₂ are removed from the medium-heat flue gas 547. The flue gas 503 then passes through a booster fan 504. The booster fan 504 increases the pressure of the flue gas 503 to compensate for the pressure drop through the system 500, thereby ensuring that the pressure of the resultant CO₂ lean flue gas (flue gas 507) is at the same pressure as flue gas 501, or just above at a pressure of 5 mbarg. Upon leaving the booster fan 304, flue gas 505 is formed.

The cool flue gas 505 enters the absorber 506, where the cool flue gas 505 is contacted with a cool, CO₂ lean solvent 544 in a counter-current configuration. The cool, CO₂ lean solvent 544 is typically at a temperature of 40° C. The cool flue gas 505 rises through the absorber 506. The cool, CO₂ lean solvent 544 enters the absorber 506 via a liquid distributor (not shown in FIG. 5). and then enters the absorber 506 above packing 506b and cascades down through the absorber 506. The absorber 506 contains packing to maximise the surface area to volume ratio: the packing is shown by references 506a, 506b and 506c in FIG. 5. To maintain the temperature of the absorber 506, the location of the packing (the intercooling sections) and the height of each packing will be optimised on a case-to-case basis. Once the cool, CO₂ lean solvent 544 has passed through packing 506b, a cool, CO₂ lean solvent 508 is formed and the cool, CO₂ lean solvent 508 passes to an absorber interstage pump 509 forming cool, CO₂ lean solvent 510. Approximately, 90 to 100% of the cool, CO₂ lean solvent 544 passes through the interstage pump 509 to form cool, CO₂ lean solvent 510, instead of passing directly down through the absorber 506. The cool, CO₂ lean solvent 544 that passes through the interstage pump 509 is labelled 508 in FIG. 5. The absorber interstage pump 509 is used to feed the cool, CO₂ lean solvent 510 back into the absorber 506. The cool, CO₂ lean solvent 510 then passes to an absorber interstage cooler 511 forming cool, CO₂ lean solvent 512. The absorber interstage cooler 511 removes any excess heat from the solvent during the exothermic CO₂ absorption reaction. The cool, CO₂ lean solvent 512 then continues to cascade through absorber 506. The active components in the cool, CO₂ lean solvent 544 react with the CO₂ in the cool flue gas 505. Advantageously, by cooling part of the cool, CO₂ lean solvent the temperature of the cool, CO₂ lean solvent is reduced in the bottom section of the absorber 506 (i.e., in the section below packing 506b. A cool, CO₂ lean solvent with a reduced temperature will increase the loading of CO₂ into the cool, CO₂ lean solvent, which in turn reduces the heat of absorption energy required by the absorber 506.

When the cool, CO₂ lean solvent 544 reaches the bottom of the absorber 506, it is rich in CO₂ and forms cool, CO₂ rich solvent 518. Typically, the cool, CO₂ rich solvent 518 is at a temperature of 40° C.

As the cool flue gas 505 passes up through the absorber 506, it is depleted of CO₂ and eventually forms CO₂ lean flue gas 507. When the cool flue gas 505 has passed through packing 506b, a CO₂ lean flue gas 507 is formed. The CO₂ lean flue gas passes through a water wash packing 506c to recover any solvent present in the CO₂ lean flue gas 507. The wash water 513 passes through a water wash pump 514 which provides sufficient pressure to feed the wash water 513 back into the absorber 506. Once the wash water 513 has passed through the wash water pump 514, wash water 515 is formed. Wash water 515 passes through a water wash cooler 516 to form wash water 517. The water wash cooler 516 is required to cool the CO₂ lean flue gas to recover water and any solvent present. The wash water 517 then enters the absorber 506 and passes down the absorber 506 and is withdrawn as wash water 513 at the bottom of packing 506c. Once the flue gas has been washed, the flue gas continues to pass up through the absorber 506. The flue gas is released from the top of the absorber 506 as CO₂ lean flue gas 507. The absorber 506 further includes a demister 506d, through which the CO₂ lean flue gas passes through before leaving the absorber 506. The demister is used to enhance the removal of liquid droplets from the flue gas.

The cool, CO₂ rich solvent 518 passes through a solvent pump 519 to form cool, CO₂ rich solvent 520. The cool, CO₂ rich solvent 520 is typically at a temperature of 40° C. Then the cool, CO₂ rich solvent 520 is regenerated in regenerator 526 to reform cool, CO₂ lean solvent 544. The solvent pump 519 is used to overcome the pressure loss of the cool, CO₂ rich solvent 518 on the path to the regenerator 526. The regenerator 526 contains packing to maximise the surface area to volume ratio: the packing is shown by references 526a, 526b and 526c, and a demister is shown by reference 526d in FIG. 5. The packing 526a is present in the half of the regenerator 526 connected to a reboiler 536, this part is the bottom of the regenerator 526. The packing 526c is present in the half of the regenerator 526 connected to a condenser 528, this part is the top of the regenerator 526. Packing 526b is present between packing 526a and packing 526c. The packing is placed in the specific locations in the regenerator 526 to maintain the required temperature profile in the regenerator 526.

The cool, CO₂ rich solvent 520 enters the regenerator 526 via one of two pathways.

The cool, CO₂ rich solvent 520 enters a cross-over heat exchanger 521. In the cross-over heat exchanger 521, the cool, CO₂ rich solvent 520 is heated by a low-heat, CO₂ lean solvent 541 to form a low-heat, CO₂ rich solvent. Typically, the low-heat, CO₂ lean solvent 541 is at a temperature of from 60 to 80° C., preferably at a temperature of 70° C. The low-heat, CO₂ rich solvent is at a temperature of from 60 to 80° C., preferably at a temperature of from 60 C. The cross-over heat exchanger 521 helps to reduce the heat lost from the CO₂ lean solvent in a cooler 543 further downstream: by minimising the heat lost at this stage, the amount of sensible heat required to regenerate the carbon capture solvent is reduced.

The low-heat CO₂ rich solvent is split into two streams: low-heat, CO₂ rich solvent 522 and low-heat, CO₂ rich solvent 523. Typically, the split is 10-40 weight % to low-heat, CO₂ rich solvent 522 and 60 to 90% to low-heat, CO₂ rich solvent 523.

The low-heat, CO₂ rich solvent 522 enters the regenerator 526 between packing 526b and 526c, and cascades down the regenerator 526. By providing the low-heat CO₂ rich solvent 522 between packing 526b and 526c of the regenerator 526 (instead of a high-heat CO₂ rich solvent), the heat of water vapourisation can be recovered by any water vapour present at the top of the regenerator 526 passing heat to the low-heat CO₂ rich solvent 522.

The low-heat, CO₂ rich solvent 523 passes to a cross-over heat exchanger 524. In the cross-over heat exchanger 524, the low-heat, CO₂ rich solvent 523 is heated by a high-heat, CO₂ lean solvent 540 to form a high-heat, CO₂ rich solvent 525. Typically, the high-heat, CO₂ lean solvent 540 is at a temperature of from 100 to 125° C., preferably at a temperature of 120° C. Typically, the high-heat CO₂ rich solvent 525 is at a temperature of from 100 to 120° C., preferably at a temperature of 110° C. The high-heat, CO₂ rich solvent 525 enters the regenerator 526 above packing 526a and cascades down the regenerator 526.

Inside the regenerator 526, water vapourisation and CO₂ stripping from the CO₂ rich solvent occurs. Advantageously, by providing a low-heat, CO₂ rich solvent 522 and a high-heat, CO₂ rich solvent 525, a low temperature at the top of the regenerator 526 (i.e., above packing 526b) can be achieved, and a high temperature at the bottom of the regenerator 526 (i.e., below packing 526b) can be achieved. By maintaining a high temperature at the bottom of the regenerator 526, the reaction between the active components in the carbon capture solvent and CO₂ can be reversed. By maintaining a low temperature at the top of the regenerator 526, the heat of water vapourisation can be recovered by any water vapour present at the top of the regenerator 526 passing heat to the low-heat CO₂ rich solvent 522.

Inside the regenerator 526, the low-heat, CO₂ rich solvent 522 and high-heat, CO₂ rich solvent 525 are heated through contact with hot vapour 537. Typically, the hot vapour 537 flows upwards through the regenerator 526, counter-currently to the low-heat, CO₂ rich solvent 522 and high-heat, CO₂ rich solvent 525. Upon heating, the reaction between the active components of the solvents and CO₂ reverses, releasing CO₂ and water vapour 527 and forming a high-heat, CO₂ lean solvent 535.

The CO₂ and water vapour 527 passes to a stripper condenser 528 operating at a temperature of from 35 to 40° C. The stripper condenser 528 forms a condensate 529 from the water vapour, which passes to a reflux drum 530 to form reflux condensate 532. The reflux drum 530 separates any gaseous CO₂ 531 and the reflux condensate 532. The reflux condensate 532 then passes to a reflux pump 533 to form reflux condensate 534. The reflux pump 533 is used to move the reflux condensate 534 back into the regenerator 526. The reflux condensate 534 then passes back into the regenerator 526 between packing 526c and 526d. Having passed through the stripper condenser 528, the condensate 529 and the subsequently formed reflux condensate 532 and reflux condensate 534 are at a temperature of from 35 to 40° C.

A gaseous CO₂ 531 is formed in the reflux drum 530. The gaseous CO₂ 531 is the CO₂ product stream and can be used in downstream processes.

Upon entering the regenerator 526, the reflux condensate 534 is heated by the hot vapour 537 present in the regenerator 526, forming pre-heated reflux condensate 549. Typically, the pre-heated reflux condensate 529 is heated to a temperature of from 90 to 110° C., preferably 100° C. The pre-heated reflux condensate 549 is removed from the regenerator 526 between packing 526b and 526c and passes through a pump 550 to form pre-heated reflux condensate 545. The pump 550 compensates for the pressure drop between the first heat exchanger 546 and other components on the loop comprising the first heat exchanger 546. The pre-heated reflux condensate 545 passes through the first heat exchanger 546 to be heated by the flue gas 501. Upon heating the pre-heated reflux condensate 545, hot vapour 548 is formed. Typically, the hot vapour 548 is at a temperature of from 115 to 130° C., typically a temperature of from 120 to 130° C. The hot vapour 548 enters the regenerator 526 below packing 526a. Advantageously, when the hot vapour 548 enters the regenerator 526 below packing 526a, the hot vapour 548 is at or near the bottom of the regenerator 526 and the high temperature required at the bottom of the regenerator 526 can be maintained.

The high-heat, CO₂ lean solvent 535 is fed into a reboiler 536. Typically, the reboiler 536 is operating at a temperature of 120° C. or greater, preferably at a temperature of 120° C. Within the reboiler 536, the high-heat, CO₂ lean solvent 535 is boiled using steam or any other hot medium resulting in the formation of hot vapour 537 and high-heat, CO₂ lean solvent 538. Typically, the hot vapour 537 is at a temperature of from 120° C. or greater, preferably at a temperature of 120° C. Typically, the hot vapour 537 comprises CO₂ and water vapour. The hot vapour 537 is used in the regenerator 526 and enters the regenerator below packing 526a. Typically, the high-heat, CO₂ lean solvent 538 is at a temperature of from 100 to 120° C., preferably at a temperature of 120° C.

The high-heat, CO₂ lean solvent 538 passes to a solvent pump 539 to form high-heat, CO₂ lean solvent 540. The solvent pump 539 is used to move the high-heat, CO₂ lean solvent 538 to the cross-over heat exchanger 524. The high-heat, CO₂ lean solvent 540 then passes to the cross-over heat exchanger 524. In the cross-over heat-exchanger 524, the high-heat, CO₂ lean solvent 540 is cooled to form low-heat, CO₂ lean solvent 541. The low-heat, CO₂ lean solvent 541 then passes to the cross-over heat exchanger 521. In the cross-over heat-exchanger 521, the low-heat, CO₂ lean solvent 541 is cooled by exchanging heat with cool, CO₂ rich solvent 520 to form cool, CO₂ lean solvent 542. Typically, the cool, CO₂ lean solvent 542 is at a temperature of from 40 to 60° C., preferably at a temperature of 55° C. The cool, CO₂ lean solvent 542 passes to a cooler 543 to form cool, CO₂ lean solvent 544. In the cooler 543, the cool, CO₂ lean solvent 542 is cooled to 40° C. to form cool, CO₂ lean solvent 544. Cool, CO₂ lean solvent 544 is ready to enter absorber column 506.

Advantageously, by using the heat from the flue gas 501 to heat the pre-heated reflux condensate 545, heat can be recovered from the flue gas 501 and therefore the amount of heat and steam required for the solvent regeneration is reduced. Thus, energy and therefore also costs, are reduced.

Further advantageously, by removing the pre-heated reflux condensate 549 from the top of the regenerator 526 the amount of CO₂ and water vapour 527 produced is reduced, which in turn reduces the condenser 528 duty.

Further advantageously, by removing the pre-heated reflux condensate 549 from the top of the regenerator 526, the temperature experienced by the condenser 528 will be reduced, thereby reducing the load on the condenser 528. This reduces the amount of water vapour emissions which are present in the gaseous CO₂ 531. Furthermore, this reduces the temperature of the vapour 527 passing to the condenser 528, thereby decreasing the heat duty and the condenser 528 size.

Further advantageously, the amount of vapour passing to the condenser 528 is reduced, which will reduce the solvent contamination in the gaseous CO₂ 531 produced.

Further advantageously, by using heat from the flue gas 501 to heat the pre-heated reflux condensate 545, heat recovery from the cross-over heat exchangers 521 and 524 is not limited, thereby maximising the heat that can be recovered from the flue gas 501.

Further advantageously, by using heat from the flue gas 501, the load on the flue gas cooling part of the system 500 (i.e., direct contact cooler 502) is reduced and as a result can reduce the equipment size of the equipment used in the flue gas cooling part of the system 500.

### System 600: a System and Method of the Present Invention

FIG. 6 illustrates a schematic diagram of a system 600 for capturing CO₂ from flue gases. In the system 600 for capturing CO₂ from flue gases shown in FIG. 6, CO₂ is separated from a mixture of gases using a solvent (initially a CO₂ lean solvent), which selectively reacts with the CO₂ (to form a CO₂ rich solvent). After the CO₂ has reacted with the solvent (CO₂ lean solvent), the solvent (CO₂ rich solvent) can be regenerated (to CO₂ lean solvent) using heat to release the CO₂ and regenerate the solvent for further CO₂ processing.

As shown in FIG. 6 (indicating a system of the present invention), a flue gas 601 containing CO₂ enters the system 600. The temperature of the flue gas 601 when entering the system 600 is typically greater than 100° C., typically from 120 to 200° C. The flue gas 601 is cooled to from 30 to 50° C., or 40° C. before the flue gas 601 enters the absorber 606.

The flue gas 601 passes through a first heat exchanger 646. The first heat exchanger 646 is preferably a flue gas rich solvent exchanger. In the first heat exchanger 646, the flue gas is cooled to form medium-heat flue gas 648 and the heat from the flue gas 601 is used to heat a reflux condensate 645 to form a hot vapour 647. The hot vapour 647 is comprises water vapour. Typically, the medium-heat flue gas 648 is at a temperature of 80 to 110° C., preferably 90° C. Typically, the hot vapour 647 is at a temperature of from 110 to 130° C., preferably 120° C. and as vapour.

The medium-heat flue gas 648 passes through a second heat exchanger 649. The second heat exchanger 649 is preferably a flue gas rich solvent exchanger. In the second heat exchanger 649, the low-heat flue gas is cooled to form low-heat flue gas 650 and the heat from the medium-heat flue gas 648 is used to heat a low-heat, CO₂ rich solvent 622 to form a low-heat CO₂ rich solvent 651. Typically, the low-heat flue gas 650 is at a temperature of from 55 to 80° C. Typically, the low-heat CO₂ rich solvent 651 is at a temperature of from 55 to 80° C., preferably 75° C.

The low-heat flue gas 650 optionally passes through a flue gas pre-treatment section 602. In the flue gas pre-treatment section 602, the low-heat flue gas 650 passes through a direct contact cooler. In the direct contact cooler, the low-heat flue gas 650 is contacted with a recirculating loop of cool water in a counter-current configuration. Through this contact, the low-heat flue gas 650 is cooled. The cooled flue gas forms flue gas 603, which is cooled to a temperature of typically 40° C. Optionally through contact with an alkali solution, SO₂ and NO₂ are removed from the low-heat flue gas 650. The flue gas 603 then passes through a booster fan 604. The booster fan 604 increases the pressure of the flue gas 603 to compensate for the pressure drop through the system 600, thereby ensuring that the pressure of the resultant CO₂ lean flue gas (flue gas 607) is at the same pressure as flue gas 601, or just above at a pressure of 5 mbarg. Upon leaving the booster fan 604, flue gas 605 is formed.

The cool flue gas 605 enters the absorber 606, where the cool flue gas 605 is counter-currently contacted with a cool, CO₂ lean solvent 644 in a counter-current configuration. The cool, CO₂ lean solvent 644 is typically at a temperature of 40° C. The cool flue gas 605 rises through the absorber 606. The cool, CO₂ lean solvent 644 enters the absorber 606 via a liquid distributor (not shown in FIG. 6). and then enters the absorber 606 above packing 606b and cascades down through the absorber 606. The absorber 606 contains packing to maximise the surface area to volume ratio: the packing is shown by references 606a, 606b and 606c in FIG. 6. To maintain the temperature of the absorber 606, the location of the packing (the intercooling sections) and the height of each packing will be optimised on a case-to-case basis. Once the cool, CO₂ lean solvent 644 has passed through packing 606b, a cool, CO₂ lean solvent 608 is formed and the cool, CO₂ lean solvent 608 passes to an absorber interstage pump 609 forming cool, CO₂ lean solvent 610. Approximately, 90 to 100% of the cool, CO₂ lean solvent 644 passes through the interstage pump 609 to form cool, CO₂ lean solvent 610, instead of passing directly down through the absorber 606. The cool, CO₂ lean solvent 644 that passes through the interstage pump 609 is labelled 608 in FIG. 6. The absorber interstage pump 609 is used to feed the cool, CO₂ lean solvent 610 back into the absorber 606. The cool, CO₂ lean solvent 610 then passes to an absorber interstage cooler 611 forming cool, CO₂ lean solvent 612. The absorber interstage cooler 611 removes any excess heat from the solvent during the exothermic CO₂ absorption reaction. The cool, CO₂ lean solvent 612 then continues to cascade through absorber 606. The active components in the cool, CO₂ lean solvent 612 reacts with the CO₂ in the cool flue gas 605. Advantageously, by cooling part of the cool, CO₂ lean solvent the temperature of the cool, CO₂ lean solvent is reduced in the bottom section of the absorber 606 (i.e., in the section below packing 606b). A cool, CO₂ lean solvent with a reduced temperature will increase the loading of CO₂ into the cool, CO₂ lean solvent, which in turn reduces the heat of absorption energy required by the absorber 606.

When the cool, CO₂ lean solvent 612 reaches the bottom of the absorber 606, it is rich in CO₂ and forms cool, CO₂ rich solvent 618. Typically, the cool, CO₂ rich solvent 618 is at a temperature of 40° C.

As the cool flue gas 605 passes up through the absorber 606, it is depleted of CO₂ and eventually forms CO₂ lean flue gas 607. When the cool flue gas 605 has passed through packing 606b, a CO₂ lean flue gas is formed. The CO₂ lean flue gas passes through a water wash packing 606c to recover any solvent present in the CO₂ lean flue gas. The wash water 613 passes through a water wash pump 614 which provides sufficient pressure to feed the wash water 613 back into the absorber 606. Once the wash water 613 has passed through the wash water pump 614, wash water 615 is formed. Wash water 615 passes through a water wash cooler 616 to form wash water 617. The water wash cooler 616 is required to cool the CO₂ lean flue gas to recover water and any solvent present. The wash water 617 then enters the absorber 606 and passes down the absorber 606 and is withdrawn as wash water 613 at the bottom of packing 606c. Once the flue gas has been washed, the flue gas 605 continues to pass up through the absorber 606. The flue gas is released from the top of the absorber 606 as CO₂ lean flue gas 607. The absorber 606 further includes a demister 606d, through which the CO₂ lean flue gas passes through before leaving the absorber 606. The demister is used to enhance the removal of liquid droplets from the flue gas.

The stream of the cool, CO₂ rich solvent 618 passes through a solvent pump 619 to form cool, CO₂ rich solvent 620. Typically, the cool, CO₂ rich solvent 620 is at a temperature of 40° C. Then the cool, CO₂ rich solvent 620 is regenerated in regenerator 626 to reform cool, CO₂ lean solvent 644. The solvent pump 619 is used to overcome the pressure loss of the cool, CO₂ rich solvent 618 on the path to the regenerator 626. The regenerator 626 contains packing to maximise the surface area to volume ratio: the packing is shown by references 626a, 626b and 626c, and a demister is shown by reference 626d in FIG. 6. The packing 626a is present in the half of the regenerator 626 connected to a reboiler 636, this part is the bottom of the regenerator 626. The packing 626c is present in the half of the regenerator 626 connected to a condenser 628, this part is the top of the regenerator 626. Packing 626b is present between packing 626a and packing 626c. The packing is placed in the specific locations in the regenerator 626 to maintain the required temperature profile in the regenerator 626.

The cool, CO₂ rich solvent 620 enters the regenerator 626 via one of three pathways. In all three pathways, the cool, CO₂ rich solvent 620 enters a cross-over heat exchanger 621. In the cross-over heat exchanger 621, the cool, CO₂ rich solvent 620 is heated by a low-heat, CO₂ lean solvent 623 to form a low-heat, CO₂ rich solvent. Typically, the low-heat, CO₂ lean solvent 623 is at a temperature of from 60 to 80° C., preferably at a temperature of from 70° C. The low-heat, CO₂ rich solvent is at a temperature of from 60 to 80° C., preferably at a temperature of from 70° C. The cross-over heat exchanger 621 helps to reduce the heat lost from the CO₂ lean solvent in a cooler 643 further downstream: by minimising the heat lost at this stage, the amount of sensible heat required to regenerate the carbon capture solvent is reduced.

The low-heat, CO₂ rich solvent is split into three streams. One stream, low-heat, CO₂ rich solvent 641, enters the regenerator 626 between packing 626c and demister 626d, and cascades down the regenerator 626. By providing the low-heat CO₂ rich solvent 622 between packing 626c and demister 626d of the regenerator 626 (instead of a high-heat CO₂ rich solvent), the heat of water vapourisation can be recovered by any water vapour present at the top of the regenerator 626 passing heat to the low-heat CO₂ rich solvent 641.

The second stream, low-heat CO₂ rich solvent 622, passes to a second heat exchanger 649 where it is heated by medium-heat flue gas 648 to form low-heat CO₂ rich solvent 651. Typically, the low-heat CO₂ rich solvent 651 is at a temperature of from 60 to 80° C., preferably 75° C. The low-heat CO₂ rich solvent 651 enters the regenerator 626 between packing 626b and packing 626c. By using heat from the medium-heat flue gas 648 to heat the low-heat CO₂ rich solvent 622, the amount of energy required by the regenerator 626 to heat the CO₂ rich solvent is reduced. The low-heat, CO₂ rich solvent 651 enters the regenerator 626 between packing 626b and 626c and cascades down the regenerator 626. By providing the low-heat CO₂ rich solvent 622 between packing 626b and 626c of the regenerator 626 (instead of a high-heat CO₂ rich solvent), the heat of water vapourisation can be recovered by any water vapour present at the top of the regenerator 626 passing heat to the low-heat CO₂ rich solvent 651.

The third stream, low-heat CO₂ rich solvent, passes to a cross-over heat exchanger 624. In the cross-over heat exchanger 624, the low-heat, CO₂ rich solvent is heated by a high-heat, CO₂ lean solvent 640 to form a high-heat, CO₂ rich solvent 625. Typically, the high-heat, CO₂ lean solvent 640 is at a temperature of from 100 to 120° C., preferably at a temperature of 120° C. Typically, the high-heat CO₂ rich solvent 625 is at a temperature of from 100 to 110° C., preferably at a temperature of 110° C. The high-heat, CO₂ rich solvent 625 enters the regenerator 626 above packing 626a and cascades down the regenerator 626.

Inside the regenerator 626, water vapourisation and CO₂ stripping from the CO₂ rich solvent occurs. Advantageously, by providing a low-heat, CO₂ rich solvent 651, a low-heat, CO₂ rich solvent 641 and a high-heat, CO₂ rich solvent 625, a low temperature at the top of the regenerator 626 (i.e., above packing 626b) can be achieved, and a high temperature at the bottom of the regenerator 626 (i.e., below packing 626b) can be achieved. By maintaining a high temperature at the bottom of the regenerator 626, the reaction between the active components in the carbon capture solvent and CO₂ can be reversed. By maintaining a low temperature at the top of the regenerator 626, the heat of water vapourisation can be recovered by any water vapour present at the top of the regenerator 626 passing heat to the low-heat CO₂ rich solvent 651.

Inside the regenerator 626, the CO₂ rich solvent is heated through contact with hot vapour 637 and hot vapour 647. Typically, the hot vapour 637 and hot vapour 647 flow upwards through the regenerator 626, counter-currently to the low-heat, CO₂ rich solvent 622. Upon heating, the reaction between the active components of the solvents and CO₂ reverses, releasing CO₂ and water vapour 627 and forming a high-heat, CO₂ lean solvent 635.

The CO₂ and water vapour 627 passes to a stripper condenser 628 operating at a temperature of from 35 to 40° C. The stripper condenser 628 forms a reflux condensate 629 from the water vapour, which passes to a reflux drum 630 to form reflux condensate 632. The reflux drum 630 separates gaseous CO₂ 631 and the reflux condensate 632. A gaseous CO₂ 631 is formed in the reflux drum 630. The gaseous CO₂ 631 is the CO₂ product stream and can be used in downstream processes. The reflux condensate 632 then passes to a reflux pump 633 and the resultant reflux condensate is split into two streams: reflux condensate 645 and reflux condensate 634 which passes back into the regenerator 626 between packing 626c and 626d. The reflux pump 633 is used to move the reflux condensate 634 back into the regenerator 626. Having passed through the stripper condenser 628, the condensate 629 and the subsequently formed reflux condensate 632 and reflux condensate 634 are at a temperature of from 35 to 40° C.

The reflux condensate 645 passes to the first heat exchanger 646 where it is heated by flue gas 601 to form hot vapour 647. Typically, the hot vapour 647 is at a temperature of from 110 to 130° C., preferably 120° C. The hot vapour 647 passes to the regenerator 626, where it enters the regenerator 626 below packing 626a. Advantageously, when the hot vapour 647 enters the regenerator 626 below packing 626a, the hot vapour 647 is at or near the bottom of the regenerator 626, and as a result the high temperature required at the bottom of the regenerator 626 can be maintained, advantageously reducing the amount of energy required by system 600 as well as reducing the cost required to regenerate the cool, CO₂ lean solvent 644.

The high-heat, CO₂ lean solvent 635 is fed into a reboiler 636. Typically, the reboiler 636 is operating at a temperature of 120° C. or greater, preferably at a temperature of 120° C. Within the reboiler 636, the high-heat, CO₂ lean solvent 635 is boiled using steam or any other hot medium resulting in the formation of hot vapour 637 and high-heat, CO₂ lean solvent 638. Typically, the hot vapour 637 is at a temperature of from 120° C. or greater, preferably at a temperature of 120° C. Typically, the hot vapour 637 comprises CO₂ and water vapour. The hot vapour 637 is used in the regenerator 626. Typically, the high-heat, CO₂ lean solvent 638 is at a temperature of from 100 to 120° C., preferably at a temperature of 120° C.

The high-heat, CO₂ lean solvent 638 passes to a solvent pump 639 to form high-heat, CO₂ lean solvent 640. The high-heat, CO₂ lean solvent 640 then passes to the cross-over heat exchanger 624. In the cross-over heat-exchanger 624, the high-heat, CO₂ lean solvent 640 is cooled to form low-heat, CO₂ lean solvent 623 by exchanging heat with the low-heat, CO₂ rich solvent formed in the cross-over heat exchanger 621.

The low-heat, CO₂ lean solvent 623 then passes to the cross-over heat exchanger 621. In the cross-over heat-exchanger 621, the low-heat, CO₂ lean solvent 623 is cooled by exchanging heat with cool, CO₂ rich solvent 620 to form cool, CO₂ lean solvent 642. The cool, CO₂ lean solvent 642 passes to cooler 643 to form cool, CO₂ lean solvent 644. Cool, CO₂ lean solvent 644 is ready to enter absorber column 606.

Advantageously, by using the heat from the flue gas 601 to heat reflux condensate 645 and low-heat, CO₂ rich solvent, heat can be recovered from the flue gas 601 and therefore the amount of heat and steam required for the solvent regeneration is reduced. Thus, net energy demand and therefore also costs, are reduced.

Further advantageously, by using heat from the flue gas 601 to heat the reflux condensate 645, heat recovery on the cross-over heat exchangers 621 and 624 is not limited, thereby maximising the heat that can be recovered from the flue gas 601.

Further advantageously, by using heat from the flue gas 601, the load on the flue gas cooling part of the system 600 (i.e., the flue-gas pre-treatment 602, and in particular the direct contact cooler) is reduced and as a result can reduce the equipment size of the equipment used in the flue gas cooling part of the system 600.

Further advantageously, by using heat from the flue gas 601 to heat the reflux condensate 645 before using heat from the medium-heat flue gas 648 to heat the low-heat, CO₂ rich solvent 622, the temperature at which the low-heat, CO₂ rich solvent 622 is heated to is less than if heat from the flue gas 601 is used to heat the low-heat, CO₂ rich solvent 622. This will reduce the medium heat flue gas 650 temperature further and also minimises the heat loss in lean solvent cooler 643.

Further advantageously, by using heat from the flue gas 601 in the regeneration of the solvent to heat the reflux condensate 645, maximum heat recovery can occur. Heat from the flue gas 601 cannot always be used to heat the low-heat, CO₂ rich solvent 622 and therefore by heating the reflux condensate 645, heat loss through the lean solvent cooler 643 is reduced.

### System 700: a System and Method of the Present Invention

FIG. 7 illustrates a schematic diagram of a system 700 for capturing CO₂ from flue gases. In the system 700 for capturing CO₂ from flue gases shown in FIG. 7, CO₂ is separated from a mixture of gases using a solvent (initially a CO₂ lean solvent), which selectively reacts with the CO₂ (to form a CO₂ rich solvent). After the CO₂ has reacted with the solvent (CO₂ lean solvent), the solvent (CO₂ rich solvent) can be regenerated (to CO₂ lean solvent) using heat to release the CO₂ and regenerate the solvent for further CO₂ processing.

As shown in FIG. 7 (indicating a system of the present invention), a flue gas 701 containing CO₂ enters the system 700. The temperature of the flue gas 701 when entering the system 700 is typically greater than 100° C., typically from 120 to 200° C.

The flue gas 701 is cooled to from 30 to 50° C., or 40° C. before the flue gas 701 enters the absorber 706.

The flue gas 701 passes through a first heat exchanger 748. The first heat exchanger 748 is preferably a flue gas rich solvent exchanger. In the first heat exchanger 748, the flue gas is cooled to form medium-heat flue gas 750 and the heat from the flue gas 701 is used to heat a pre-heated reflux condensate 747 which is heated to form hot vapour 749. Typically, the medium-heat flue gas 750 is at a temperature of 80 to 110° C., preferably at 90° C. Typically, the hot vapour 749 is at a temperature of from 110 to 130° C., preferably 120° C. The pre-heated reflux condensate 747 comprises water vapour.

The medium-heat flue gas 750 passes through a second heat exchanger 751. The second heat exchanger 751 is preferably a flue gas rich solvent exchanger. In the second heat exchanger 751, the medium-heat flue gas 750 is cooled to a low-heat flue gas 752 by exchanging heat with cool, CO₂ rich solvent 720. The heat from the medium-heat flue gas 750 heats the cool, CO₂ rich solvent 720 to form low-heat CO₂ rich solvent 753. Typically, the low-heat flue gas 752 is at a temperature of from 55 to 80° C. Typically, the low-heat, CO₂ rich solvent 753 is at a temperature of from 50 to 80° C., preferably 75° C.

The low-heat flue gas 752 optionally passes through a flue gas pre-treatment section 702. In the flue gas pre-treatment section 702, the low-heat flue gas 752 passes through a direct contact cooler. In the direct contact cooler, the low-heat flue gas 752 is contacted with a recirculating loop of cool water in a counter-current configuration. Through this contact, the low-heat flue gas 752 is cooled. The cooled flue gas forms flue gas 703, which is cooled to a temperature of typically 40° C. Optionally, through contact with an alkali solution SO₂ and NO₂ are removed from the low-heat flue gas 752. The flue gas 703 then passes through a booster fan 704. The booster fan 704 increases the pressure of the flue gas 703 to compensate for the pressure drop through the system 700, thereby ensuring that the pressure of the resultant CO₂ lean flue gas (flue gas 707) is at the same pressure as flue gas 701, or just above at a pressure of 5 mbarg. Upon leaving the booster fan 704, flue gas 705 is formed.

The cool flue gas 705 enters an absorber 706, where the cool flue gas 705 is contacted with a cool, CO₂ lean solvent 744 in a counter-current configuration. The cool, CO₂ lean solvent 744 is typically at a temperature of 40° C. The cool flue gas 705 rises through the absorber 706. The cool, CO₂ lean solvent 744 enters the absorber 706 via a liquid distributor (not shown in FIG. 7), and then enters the absorber 706 at the top of packing 706b and cascades down through the absorber 706. The absorber 706 contains packing to maximise the surface area to volume ratio: the packing is shown by references 706a, 706b and 706c in FIG. 7. To maintain the temperature of the absorber 706, the location of the packing (the intercooling sections) and the height of each packing will be optimised on a case-to-case basis. Once the cool, CO₂ lean solvent 744 has passed through packing 706b, a cool, CO₂ lean solvent 708 is formed and the cool, CO₂ lean solvent 708 passes to an absorber interstage pump 709 forming cool, CO₂ lean solvent 710. Approximately, 90 to 100% of the cool, CO₂ lean solvent 744 passes through the interstage pump 709 to form cool, CO₂ lean solvent 710, instead of passing directly down through the absorber 706. The cool, CO₂ lean solvent 744 that passes through the interstage pump 709 is labelled 708 in FIG. 7. The absorber interstage pump 709 is used to feed the cool, CO₂ lean solvent 710 back into the absorber 706. The cool, CO₂ lean solvent 710 then passes to an absorber interstage cooler 711 forming cool, CO₂ lean solvent 712. The absorber interstage cooler 711 removes any excess heat from the solvent during the exothermic CO₂ absorption reaction. The cool, CO₂ lean solvent 712 then continues to cascade through absorber 706. The active components in the cool, CO₂ lean solvent 712 react with the CO₂ in the cool flue gas 705.

Advantageously, by cooling part of the cool, CO₂ lean solvent the temperature of the cool, CO₂ lean solvent is reduced in the bottom section of the absorber 708 (i.e., in the section below packing 706b. A cool, CO₂ lean solvent with a reduced temperature will increase the loading of CO₂ into the cool, CO₂ lean solvent, which in turn reduces the heat of absorption energy required by the absorber 706.

When the cool, CO₂ lean solvent 712 reaches the bottom of the absorber 706, it is rich in CO₂ and forms cool, CO₂ rich solvent 718. Typically, the cool, CO₂ rich solvent 718 is at a temperature of 40° C.

As the cool flue gas 705 passes up through the absorber 706, it is depleted of CO₂ and eventually forms CO₂ lean flue gas 707. When the flue gas 705 has passed through packing 706b, a CO₂ lean flue gas is formed. The CO₂ lean flue gas passes through a water wash packing 706c to recover any solvent present in the CO₂ lean flue gas. The CO₂ lean flue gas 713 passes through a water wash pump 714 which provides sufficient pressure to feed the wash water 713 back into the absorber 706. Once the wash water 713 has passed through the wash water pump 714, wash water 715 is formed. Wash water 715 passes through a water wash cooler 716 to form wash water 717. The water wash cooler 716 is required to cool the CO₂ lean flue gas to recover water and any solvent present. The wash water 717 then enters the absorber 706 and passes down the absorber 706 and is withdrawn as wash water 713 at the bottom of packing 706c. Once the flue gas has been washed, the flue gas continues to pass up through the absorber 706. The flue gas is then released from the top of the absorber 706 as CO₂ lean flue gas 707. The absorber 706 further includes a demister 706d, through which the CO₂ lean flue gas passes through before leaving the absorber 706. The demister is used to enhance the removal of liquid droplets from the flue gas.

The stream of the cool, CO₂ rich solvent 718 passes through a solvent pump 719 to form cool, CO₂ rich solvent 720. Typically, the cool, CO₂ rich solvent 720 is at a temperature of 40° C. Then the cool, CO₂ rich solvent 720 is regenerated in regenerator 726 to reform cool, CO₂ lean solvent 744. The solvent pump 719 is used to overcome the pressure loss of the cool, CO₂ rich solvent 718 on the path to the regenerator 726. The regenerator 726 contains packing to maximise the surface area to volume ratio: the packing is shown by references 726a, 726b, 726c and 726d, and a demister is shown by reference 726e in FIG. 7. The packing 726a is present in the half of the regenerator 726 connected to a reboiler 736, this part is the bottom of the regenerator 726. The packing 726c is present in the half of the regenerator 726 connected to a condenser 728, this part is the top of the regenerator. Packing 726b is present between packing 726a and packing 726c. The packing is placed in the specific locations in the regenerator 726 to maintain the required temperature profile in the regenerator 726.

The cool, CO₂ rich solvent 720 enters the regenerator 726 via one of three pathways.

The cool, CO₂ rich solvent 720 is split into two streams. One stream passes to the second heat exchanger 751. As discussed above, the cool, CO₂ rich solvent 720 exchanges heat with the medium-heat flue gas 750 to form low-heat CO₂ rich solvent 753. Typically, the low-heat, CO₂ rich solvent 753 is at a temperature of from 60 to 80° C., preferably 75° C. The low-heat CO₂ rich solvent 753 enters the regenerator 726 between packing 726c and 726d. By using heat from medium-heat flue gas 750 to heat the cool CO₂ rich solvent 720, the amount of energy required by the regenerator 726 to heat the CO₂ rich solvent is reduced.

The second stream of the cool, CO₂ rich solvent 720 enters a cross-over heat exchanger 721. In the cross-over heat exchanger 721, the cool, CO₂ rich solvent 720 is heated by a low-heat, CO₂ lean solvent 741 to form a low-heat, CO₂ rich solvent. Typically, the low-heat, CO₂ lean solvent 741 is at a temperature of from 60 to 80° C., preferably at a temperature of 70° C. The low-heat, CO₂ rich solvent is at a temperature of from 60 to 80° C., preferably at a temperature of from 60 to 70° C. The cross-over heat exchanger 721 helps to reduce the heat lost from the CO₂ lean solvent in a cooler 743 further downstream: by minimising the heat lost at this stage, the amount of sensible heat required to regenerate the carbon capture solvent is reduced.

The low-heat CO₂ rich solvent is split into two streams: low-heat, CO₂ rich solvent 722 and low-heat, CO₂ rich solvent 723. Typically, the split is 10-40 weight % to low-heat, CO₂ rich solvent 22 and 60 to 90% to low-heat, CO₂ rich solvent 723.

The low-heat, CO₂ rich solvent 722 enters the regenerator 726 between packing 726c and 726d and cascades down the regenerator 26. By providing the low-heat CO₂ rich solvent 722 between packing 726c and 726d of the regenerator 726 (instead of a high-heat CO₂ rich solvent), the heat of water vapourisation can be recovered by any water vapour present at the top of the regenerator 726 passing heat to the low-heat CO₂ rich solvent 722.

The low-heat, CO₂ rich solvent 723 passes to a cross-over heat exchanger 724. In the cross-over heat exchanger 724, the low-heat, CO₂ rich solvent 723 is heated by a high-heat, CO₂ lean solvent 740 to form a high-heat, CO₂ rich solvent 725. Typically, the high-heat, CO₂ lean solvent 740 is at a temperature of from 100 to 120° C., preferably at a temperature of 120° C. Typically, the high-heat CO₂ rich solvent 725 is at a temperature of from 100 to 120° C., preferably at a temperature of 110° C. The high-heat, CO₂ rich solvent 725 enters the regenerator 726 at the top of packing 716a and cascades down the regenerator 726.

Inside the regenerator 726, water vapourisation and CO₂ stripping from the CO₂ rich solvent occurs. Advantageously, by providing a low-heat, CO₂ rich solvent 722, a low-heat CO₂ rich solvent 753 and a high-heat, CO₂ rich solvent 725, a low temperature at the top of the regenerator 726 (i.e., between packing 726c and 726d) can be achieved, and a high temperature at the bottom of the regenerator 726 (i.e., between packing 726a and 726b) can be achieved. By maintaining a high temperature at the bottom of the regenerator 726, the reaction between the active components in the carbon capture solvent and CO₂ can be reversed. By maintaining a low temperature at the top of the regenerator 726, the heat of water vapourisation can be recovered by any water vapour present at the top of the regenerator 726 passing heat to the low-heat CO₂ rich solvent 722.

Inside the regenerator 726, the low-heat, CO₂ rich solvent 722, low-heat CO₂ rich solvent 753 and high-heat, CO₂ rich solvent 725 are heated through contact with hot vapour 737. Typically, the hot vapour 737 flows upwards through the regenerator 726, counter-currently to the low-heat, CO₂ rich solvent 722, low-heat CO₂ rich solvent 753 and high-heat, CO₂ rich solvent 725. Upon heating, the reaction between the active components of the solvents and CO₂ reverses, releasing CO₂ and water vapour 727 and forming a high-heat, CO₂ lean solvent 735.

The CO₂ and water vapour 727 passes to a stripper condenser 728 operating at a temperature of from 35 to 40° C. The stripper condenser 728 forms a reflux condensate 729 from the water vapour, which passes to a reflux drum 730 to form reflux condensate 732. The reflux drum 730 separates gaseous CO₂ 731 and the reflux condensate 732. The reflux condensate 732 then passes to a reflux pump 733 to form reflux condensate 734. The reflux pump 733 is used to move the reflux condensate 734 back into the regenerator 726. The reflux condensate 734 then passes back into the regenerator 726 between packing 726d and demister 726e. Having passed through the stripper condenser 728, the condensate 729 and the subsequently formed reflux condensate 732 and reflux condensate 734 are at a temperature of from 35 to 40° C.

A gaseous CO₂ 731 is formed in the reflux drum 730. The gaseous CO₂ 731 is the CO₂ product stream and can be used in downstream processes.

Upon entering the regenerator 726, the reflux condensate 729 is heated by the hot vapour 737 present in the regenerator 726, forming pre-heated reflux condensate 745. Typically, the pre-heated reflux condensate is at a temperature of from 90 to 110° C., preferably 100° C. The pre-heated reflux condensate 745 is removed from the regenerator 726 between packing 726c and 726d and passes through pump 746 to form pre-heated reflux condensate 747. Pump 746 compensates for the pressure drop between the first heat exchanger 748 and other components on the loop comprising the first heat exchanger 748. The pre-heated reflux condensate 747 passes through the first heat exchanger 748 to be heated by the flue gas 701. Upon heating the pre-heated reflux condensate 747, hot vapour 749 is formed. Typically, the hot vapour 749 is at a temperature of from 115 to 130° C., which is the saturation temperature at stripper pressure and ensures that 100% the hot vapour 749 is vapour and so no condensate enters the reboiler 736. The hot vapour 749 enters the regenerator 726 below packing 726a which is at or near the bottom of the regenerator 726. Advantageously, when the hot vapour 749 enters the regenerator 726 below packing 726a, the high temperature required at the bottom of the regenerator 726 can be maintained. Heat from the flue gas 701 can be used to heat the pre-heated reflux condensate 747, advantageously reducing the amount of energy required by system 700 as well as reducing the cost required to regenerate the cool, CO₂ lean solvent 744.

The high-heat, CO₂ lean solvent 735 is fed into a reboiler 736. Typically, the reboiler 736 is operating at a temperature of 120° C. or greater, preferably at a temperature of 120° C. Within the reboiler 736, the high-heat, CO₂ lean solvent 735 is boiled using steam or any other hot medium resulting in the formation of hot vapour 737 and high-heat, CO₂ lean solvent 738. Typically, the hot vapour 737 is at a temperature of from 120° C. or greater, preferably at a temperature of 120° C. Typically, the hot vapour 737 comprises CO₂ and water vapour. The hot vapour 737 is used in the regenerator 726, and the hot vapour enters the regenerator below packing 726a. Typically, the high-heat, CO₂ lean solvent 738 is at a temperature of from 100 to 120° C., preferably at a temperature of 120° C.

The high-heat, CO₂ lean solvent 738 passes to a solvent pump 739 to form high-heat, CO₂ lean solvent 740. The solvent pump 743 is used to move the high-heat, CO₂ lean solvent 738 to the cross-over heat exchanger 724. The high-heat, CO₂ lean solvent 740 then passes to the cross-over heat exchanger 724. In the cross-over heat-exchanger 724, the high-heat, CO₂ lean solvent 740 is cooled to form low-heat, CO₂ lean solvent 741. The low-heat, CO₂ lean solvent 741 then passes to the cross-over heat exchanger 721. In the cross-over heat-exchanger 721, the low-heat, CO₂ lean solvent 741 is cooled by exchanging heat with cool, CO₂ rich solvent 720 to form cool, CO₂ lean solvent 742. Typically, the cool, CO₂ lean solvent 742 is at a temperature of from 40 to 60° C., preferably at a temperature of 55° C. The cool, CO₂ lean solvent 742 passes to cooler 743 to form cool, CO₂ lean solvent 744. In the cooler 743, the cool, CO₂ lean solvent 342 is cooled to 40° C. to form cool, CO₂ lean solvent 544. Cool, CO₂ lean solvent 744 is ready to enter absorber column 706.

Advantageously, by using the heat from the flue gas 701 to heat the pre-heated reflux condensate 747 and low-heat CO₂ rich solvent, heat can be recovered from the flue gas 701. Thus, net energy demand and therefore also costs, are reduced.

Further advantageously, by removing the pre-heated reflux condensate 745 from the top of the regenerator 726, the amount of CO₂ and water vapour produced is reduced, which in turn reduces the condenser 728 duty.

Further advantageously, by removing the pre-heated reflux condensate 745 from the top of the regenerator 726, the temperature experienced by the condenser 728 will be reduced, thereby reducing the load on the condenser 728. This reduces the amount of water vapour emissions which are present in the gaseous CO₂ 731. Furthermore, this reduces the temperature of the vapour 727 passing to the stripper condenser 728, thereby decreasing the heat duty and the condenser 728 size.

Further advantageously, the amount of vapour passing to the condenser 728 is reduced, which will reduce the solvent contamination in the gaseous CO₂ 731 produced. By removing the pre-heated reflux condensate 745 from the top of the regenerator 726, the temperature of the pre-heated reflux condensate 745 withdrawn from the regenerator 726 is high (at a temperature of 90 to 110° C.). Therefore, the pre-heated condensate 745 requires less heating and thus more of the pre-heated reflux condensate 745 can be used to recover heat from the flue gas 701, again increasing the heat recovered from the flue gas 701.

Further advantageously, by using heat from the flue gas 701 to heat the pre-heated reflux condensate 745, heat recovery from the cross-over heat exchangers 721 and 724 is not limited, thereby maximising the heat that can be recovered from the flue gas 701.

Further advantageously, by using heat from the flue gas 701, the load on the flue gas cooling part of the system 700 (i.e., direct contact cooler 704) is reduced and as a result can reduce the equipment size of the equipment used in the flue gas cooling part of the system 700.

Further advantageously, by using heat from the flue gas 701 to heat the pre-heated reflux condensate 747 before using heat from the medium-heat flue gas 750 to heat the cool, CO₂ rich solvent 720, the temperature at which the cool, CO₂ rich solvent 720 is heated to is less than if heat from the flue gas 701 is used to heat the cool, CO₂ rich solvent 720. This will reduce the medium heat flue gas 750 temperature further and also minimises the heat loss in the lean solvent cooler 743.

Further advantageously, by using heat from the flue gas 701 in the regeneration of the solvent to heat the pre-heated reflux condensate 747, maximum heat recovery can occur. Heat from the flue gas 701 cannot always be used to heat the low-heat, CO₂ rich solvent 751 and therefore by heating the pre-heated reflux condensate 747, heat loss is reduced.

### Example 8: Determination of the Energy Demand of Systems 200-700

In one non-limiting example of the present invention, system 200 was compared with systems 300, 400, 500, 600 and 700.

In this non-limiting example, CDRMax solvent (as sold by Carbon Clean Solution Ltd) was used in systems 200, 300, 400, 500, 600 and 700. CDRMax is an example of a solvent that can be used in systems 200-700, and other solvents can be used. In this non-limiting example, Protreat® software by Optimized Gas Treating Inc. (OGT) was used, in which, the CDRMax® solvent had already been modelled was used for the simulation of these systems to estimate the energy required for 90% CO₂ recovery from flue gas.

In this non-limiting example, a flue gas comprising 4 mol % CO₂ was used in systems 200, 300, 400, 500, 600 and 700 and the amount of energy required to remove from 4035-4058 kg/hour was monitored. The removal of CO₂ (90% of the CO₂ in the flue gas) was estimated using the Protreat simulation tool. The results are tabulated in Table 1.

TABLE 1
The energy required to remove 4035-4058 kg/hour
from a flue gas comprising 4 mol % CO₂.

| System | 200 | 300 | 400 | 500 | 600 | 700 |
|---|---|---|---|---|---|---|
| CO₂ concentration of | 4 | 4 | 4 | 4 | 4 | 4 |
| initial flue gas (mol | | | | | | |
| %) | | | | | | |
| CO₂ removed | 4058 | 4045 | 4054 | 4047 | 4053 | 4035 |
| (kg/hour) | | | | | | |
| Net specific energy | 3.26 | 2.74 | 2.13 | 2.03 | 2.00 | 2.01 |
| demand (Gl/Ton of | | | | | | |
| CO₂) | | | | | | |
| Energy savings % | — | 16.14 | 34.69 | 37.92 | 38.71 | 38.71 |

As can be seen from Table 1, when a carbon capture solvent is regenerated by using heat from an incoming flue gas, net energy required can be saved in the regeneration of a carbon capture solvent.

Advantageously, equipment size in flue gas pre-treatment and coolers used in the systems to regenerate the carbon capture solvent can be reduced due to heat being recovered from the flue gas.

Further advantageously, by recovering heat from the flue gas costs will be saved in the cooling water required by the system: the cooling load of the direct contact cooler and stripper condensers will be lower.

Further advantageously, the reboiler size used in the systems to regenerate the carbon capture solvent can be reduced due to reduced heat.

Further advantageously, by using a heat exchanger to recover heat from a flue gas, impurities present in the flue gas can be removed. By recovering heat from the flue gas, and thereby cooling the flue gas, the flue gas could be cooled to below its acid dew point indirectly resulting in condensation of acid mist present in the flue gas and thus the removal of acid gas such as SO₃. By recovering heat from the flue gas, the cost of pre-treating the flue gas to remove impurities is reduced.

### Example 9: Determination of the Energy Demand of Systems 200-700

In one non-limiting example of the present invention, system 200 was compared with systems 300, 400, 500, 600 and 700.

In this non-limiting example, CDRMax solvent (as sold by Carbon Clean Solution Ltd) was used in systems 200, 300, 400, 500, 600 and 700. CDRMax is an example of a solvent that can be used in systems 200-700, and other solvents can be used. In this non-limiting example, Protreat® software by Optimized Gas Treating Inc. (OGT) was used, in which, the CDRMax® solvent had already been modelled was used for the simulation of these systems to estimate the energy required for 90% CO₂ recovery from flue gas.

In this non-limiting example, a flue gas comprising 11 mol % CO₂ was used in systems 200, 300, 400, 500, 600 and 700 and the amount of energy required to remove from 3471-3501 kg/hour was estimated. The removal of CO₂ (90% of the CO₂ in the flue gas) was estimated using the Protreat simulation tool. The results are tabulated in Table 2.

TABLE 2
The energy required to remove 3471-3501 kg/hour
of CO₂ from a flue gas comprising 11 mol % CO₂.

| System | 200 | 300 | 400 | 500 | 600 | 700 |
|---|---|---|---|---|---|---|
| CO₂ concentration | 11 | 11 | 11 | 11 | 11 | 11 |
| of initial flue gas | | | | | | |
| (mol %) | | | | | | |
| CO₂ removed | 3501 | 3498 | 3494 | 3496 | 3490 | 3471 |
| (kg/hour) | | | | | | |
| Net specific energy | 2.89 | 2.56 | 2.38 | 2.35 | 2.38 | 2.39 |
| demand (Gl/Ton of | | | | | | |
| CO₂) | | | | | | |
| Energy savings % | / | 11.59 | 17.91 | 18.97 | 17.90 | 17.90 |

As can be seen from Table 2, when a carbon capture solvent is regenerated by using heat from an incoming flue gas, net energy can be saved in the regeneration of a carbon capture solvent.

Advantageously, equipment size in flue gas pre-treatment and coolers used in the systems to regenerate the carbon capture solvent can be reduced due to heat recovery and cooling of the flue gas.

Further advantageously, by recovering heat from the flue gas costs will be saved in the cooling water required by the system used to regenerate the carbon capture solvent can be reduced due to heat being recovered from the flue gas: the cooling load of direct contact coolers and stripper condensers will be lower.

Further advantageously, the reboiler size used in the systems to regenerate the carbon capture solvent can be reduced due to reduced heat.

Further advantageously, by using a heat exchanger to recover heat from a flue gas, impurities present in the flue gas can be removed. By recovering heat from the flue gas, and thereby cooling the flue gas, the flue gas could be cooled to below its acid dew point indirectly resulting in condensation of acid mist present in the flue gas and thus the removal of acid gas such as SO₃. By recovering heat from the flue gas, the cost of pre-treating the flue gas to remove impurities is reduced.

The features disclosed in the foregoing description, or the following claims, or the accompanying drawings, expressed in their specific forms or in terms of a means for performing the disclosed function, or a method or process for attaining the disclosed result, as appropriate, may, separately, or in any combination of such features, be utilized for realizing the invention in diverse forms thereof.

Although certain example aspects of the invention have been described, the scope of the appended claims is not intended to be limited solely to these examples. The claims are to be construed literally, purposively, and/or to encompass equivalents.

1. A method for regenerating a solvent comprising carbon dioxide (CO₂), the method comprising:
providing a flue gas comprising carbon dioxide (CO₂);
passing the flue gas comprising carbon dioxide (CO₂) through a first heat exchanger, wherein heat from the flue gas is exchanged with a fluid to form a heated fluid and a cooled flue gas;
passing the heated fluid through a regenerator;
providing a solvent comprising carbon dioxide (CO₂);
passing the solvent comprising carbon dioxide (CO₂) through the regenerator, wherein heat from the heated fluid heats the solvent comprising carbon dioxide (CO₂) to form a solvent comprising a reduced amount of carbon dioxide (CO₂).

2. The method of claim 1, wherein the fluid is:
a CO₂ rich solvent; or,
a reflux condensate; or,
a pre-heated reflux condensate.

3. The method of claim 1, wherein:
the fluid is a reflux condensate and the method further comprises: passing the cooled flue gas comprising carbon dioxide (CO₂) through a second heat exchanger wherein heat from the cooled flue gas is exchanged with a CO₂ rich solvent; or
the fluid is a pre-heated reflux condensate and the method further comprises passing the cooled flue gas comprising carbon dioxide (CO₂) through a second heat exchanger wherein heat from the cooled flue gas is exchanged with a CO₂ rich solvent.

4. (canceled)

5. The method of claim 1, wherein;
the first heat exchanger decreases the temperature of the flue gas to 40 to 90° C.; or
the first heat exchanger decreases the temperature of the flue gas to 60 to 130° C.

6. (canceled)

7. The method of claim 1, wherein:
the first heat exchanger increases the temperature of the fluid to 45 to 95° C.;
the first heat exchanger increases the temperature of the fluid to 90 to 140° C.;
the fluid is a CO₂ rich solvent and the first heat exchanger increases the temperature of the CO₂ rich solvent to 45 to 95° C.;
the fluid is a reflux condensate, and the first heat exchanger increases the temperature of the reflux condensate to 90 to 140° C.; or
the fluid is a pre-heated reflux condensate, and the first heat exchanger increases the temperature of the pre-heated reflux condensate to 90 to 140° C.

8.-11. (canceled)

12. The method of claim 1, wherein;
the fluid is a reflux condensate, and the first heat exchanger increases the temperature of the reflux condensate to 90 to 140° C., and the second heat exchanger increases the temperature of the CO₂ rich solvent to 45 to 95° C.; or
the fluid is a pre-heated reflux condensate, and the first heat exchanger increases the temperature of the pre-heated reflux condensate to 90 to 140° C., and the second heat exchanger increases the temperature of the CO₂ rich solvent to 45 to 95° C.

13. (canceled)

14. The method of claim 1, further comprising at least one of:
passing the cooled flue gas through the first heat exchanger, or, the second heat exchanger, or, the first heat exchanger and the second heat exchanger, wherein the first heat exchanger, or, the second heat exchanger, or, the first heat exchanger and the second heat exchanger is (are) in fluid communication with the regenerator;
passing the solvent comprising a reduced amount of carbon dioxide (CO₂) through a reboiler, wherein the reboiler is in fluid communication with the regenerator; or
a combination thereof.

15. (canceled)

16. The method of claim 1, wherein:
the fluid is a CO₂ rich solvent and the CO₂ rich solvent enters the top of the regenerator, wherein the top of the regenerator is the part of the regenerator in fluid communication with the condenser;
the fluid is a reflux condensate, wherein upon passing the reflux condensate through the first heat exchanger a hot vapour is formed and the hot vapour enters the bottom of the regenerator, wherein the bottom of the regenerator is the part of the regenerator in fluid communication with the reboiler; or
the fluid is the pre-heated reflux condensate, wherein upon passing the pre-heated reflux condensate through the first heat exchanger a hot vapour is formed and the hot vapour enters the bottom of the regenerator, wherein the bottom of the regenerator is the part of the regenerator in fluid communication with the reboiler.

17. (canceled)

18. (canceled)

19. The method of claim 1, wherein at least one of:
the regenerator operates at a temperature in the range of equal to or greater than 120° C.;
the CO₂ rich solvent has a concentration of carbon dioxide (CO₂) of from 2 to 3.3 mol L⁻¹;
the CO₂ lean solvent has a concentration of carbon dioxide (CO₂) from 0.0 to 0.7 mol L⁻¹; or
a combination thereof.

20. (canceled)

21. (canceled)

22. The method of claim 1, wherein the step of providing a solvent comprising carbon dioxide (CO₂) further comprises:
contacting a flue gas with carbon dioxide (CO₂) lean solvent within at least one absorber column, wherein the at least one absorber column is in fluid communication with the regenerator.

23. The method of claim 22, wherein at least one of:
the at least one absorber column is in fluid communication with the regenerator through at least one cross-over heat exchanger;
the at least one absorber column comprises, or consists, of a packed column, a static column, or a rotating packed bed; or
a combination thereof.

24. (canceled)

25. The method of claim 1, wherein:
the solvent is an intensified solvent;
the solvent is an intensified solvent comprising a tertiary amine, or, a secondary amine, or, a primary amine;
the solvent is an intensified solvent further comprising a tertiary amine, a sterically hindered amine, a polyamine, a salt and water; or
the solvent is monoethanolamine (MEA) or a solvent that has 15-25 weight % 2-amino-2-methyl propanol, 15-25 weight % 1-(2-ethylamino) piperazine, 1-3 weight % 2-methylamino-2-methyl propanol, 0.1-1 weight % potassium carbonate, and the balance being deionised water.

26. The method of claim 1, wherein at least one of:
the flue gas is from a coal-fired boiler, gas-filed boiler, oil-fired boiler, combined cycle power plant, coal gasification plant, hydrogen plant, biogas plant, waste to energy plant, steel plants, refineries, cement kiln, blast furnace, or any other plant which produces a flue gas;
the flue gas has an initial carbon dioxide (CO₂) concentration of from 2.5 volume % (dry) to 51 volume % (dry);
the regenerator is either a static column or a Rotary Packed Bed (RPB); or
a combination thereof.

27. (canceled)

28. (canceled)

29. A system for regenerating a solvent comprising carbon dioxide (CO₂), the system comprising:
a first heat exchanger; and
a regenerator;
wherein the first heat exchanger exchanges heat between a flue gas comprising carbon dioxide (CO₂) and a fluid to form a heated fluid and a cooled flue gas, and the regenerator exchanges heat between the heated flue gas and a solvent comprising carbon dioxide (CO₂) to provide energy for regenerating the solvent by removing carbon dioxide (CO₂).

30. The system of claim 29, wherein the fluid is:
a CO₂ rich solvent; or,
a reflux condensate; or,
a pre-heated reflux condensate.

31. The system of claim 29, wherein:
the fluid is a reflux condensate and the system further comprises a second heat exchanger, wherein the second heat exchanger exchanges heat from the cooled flue gas with a CO₂ rich solvent; or
the fluid is a pre-heated reflux condensate and the system comprises a second heat exchanger, wherein the second heat exchanger exchanges heat from the cooled flue gas with a CO₂ rich solvent.

32. (canceled)

33. The system of claim 29, wherein:
the first heat exchanger decreases the temperature of the flue gas to 40 to 90° C., or the first heat exchanger decreases the temperature of the flue gas to 60 to 130° C.;
the first heat exchanger increases the temperature of the fluid to 45 to 95° C., or the first heat exchanger increases the temperature of the fluid to 90 to 140° C.; or
a combination thereof.

34.-36. (canceled)

37. The system of claim 29, wherein:
the fluid is a CO₂ rich solvent and the first heat exchanger increases the temperature of the CO₂ rich solvent to 45 to 95° C.;
the fluid is a reflux condensate, and the first heat exchanger increases the temperature of the reflux condensate to 90 to 140° C.; or
the fluid is a pre-heated reflux condensate, and the first heat exchanger increases the temperature of the pre-heated reflux condensate to 90 to 140° C.

38. (canceled)

39. (canceled)

40. The system of claim 29, wherein the fluid is a reflux condensate, and the first heat exchanger increases the temperature of the reflux condensate to 90 to 140° C., and the second heat exchanger increases the temperature of the CO₂ rich solvent to from 45 to 95° C.

41. The system of claim 29, wherein the fluid is a pre-heated reflux condensate, and the first heat exchanger increases the temperature of the pre-heated reflux condensate to 90 to 140° C., and the second heat exchanger increases the temperature of the CO₂ rich solvent to 45 to 95° C.

42. The system of claim 29, further comprising at least one of:
passing the cooled flue gas through the first heat exchanger, or, the second heat exchanger, or, the first heat exchanger and the second heat exchanger, wherein the first heat exchanger, or, the second heat exchanger, or, the first heat exchanger and the second heat exchanger is (are) in fluid communication with the regenerator;
passing the solvent comprising a reduced amount of carbon dioxide (CO₂) through a reboiler, wherein the reboiler is in fluid communication with the regenerator; or
a combination thereof.

43. (canceled)

44. The system of claim 29, wherein;
the fluid is a CO₂ rich solvent and the CO₂ rich solvent enters the top of the regenerator, wherein the top of the regenerator is the part of the regenerator connected to the condenser;
the fluid is a reflux condensate, wherein upon passing the reflux condensate through the first heat exchanger a hot vapour is formed and the hot vapour enters the bottom of the regenerator, wherein the bottom of the regenerator is the part of the regenerator connected to the reboiler; or
the fluid is a pre-heated reflux condensate, wherein upon passing the pre-heated reflux condensate through the first heat exchanger a hot vapour is formed and the hot vapour enters the bottom of the regenerator, wherein the bottom of the regenerator is the part of the regenerator connected to the reboiler.

45. (canceled)

46. (canceled)

47. The system of claim 29, wherein at least one of:
the regenerator operates at a temperature in the range of equal to or greater than 120° C.;
the CO₂ rich solvent has a concentration of carbon dioxide (CO₂) of from 2 to 3.3 mol L⁻¹;
the CO₂ lean solvent has a concentration of carbon dioxide (CO₂) of from 0.0 to 0.7 mol L⁻¹, or
a combination thereof.

48. (canceled)

49. (canceled)

50. The system of claim 29, wherein the step of providing a solvent comprising carbon dioxide (CO₂) further comprises:
contacting a flue gas with carbon dioxide (CO₂) lean solvent within at least one absorber column, wherein the at least one absorber column is in fluid communication with regenerator.

51. The system of claim 50, wherein at least one of:
the at least one absorber column is in fluid communication with the regenerator through at least one cross-over heat exchanger;
the at least one absorber column comprises, or consists, of a packed column, a static column, or, a rotating packed bed; or
a combination thereof.

52. (canceled)

53. The system of claim 29, wherein:
the solvent is an intensified solvent;
the solvent is an intensified solvent comprising a tertiary amine, or, a secondary amine, or, a primary amine;
the solvent is an intensified solvent further comprising a tertiary amine, a sterically hindered amine, a polyamine, a salt and water; or
the solvent is monoethanolamine (MEA) or a solvent that has 15 to 25 weight % 2-amino-2-methyl propanol, 15 to 25 weight % 1-(2-ethylamino) piperazine, 1 to 3 weight % 2-methylamino-2-methyl propanol, 0.1 to 1 weight % potassium carbonate, and the balance being deionised water.

54. The system of claim 29, wherein at least one of:
the flue gas is from a coal-fired boiler, gas-fired boiler, oil-fired boiler, combined cycle power plant, coal gasification plant, hydrogen plant, biogas plant, waste to energy plant, steel plants, refineries, cement kiln, blast furnace, or any other plant which produces a flue gas;
the flue gas has an initial carbon dioxide (CO₂) concentration of from 2.5 volume % (dry) to 51 volume % (dry);
the regenerator is either a static column or a Rotary Packed Bed (RPB); or
a combination thereof.

55. (canceled)

56. (canceled)
